(19) United States
(12) Patent Application Publication
(10) Pub. No.: US 2026/0063849 A1
(43) Pub. Date: Mar. 5, 2026

(54) MECHANICAL COUPLERS FOR FIBER ARRAY UNITS AND METHODS OF MANUFACTURING THE SAME

(71) Applicant: MELLANOX TECHNOLOGIES, LTD., Yokneam (IL)

(72) Inventors: Yaakov GRIDISH, Yoqneam Ilit (IL); Yaniv ROTEM, Nesher (IL); Elad MENTOVICH, Tel Aviv (IL); Barak FREEDMAN, Binyamina (IL); Victor BIGIO, Ramat Gan (IL)

(73) Assignee: MELLANOX TECHNOLOGIES, LTD., Yokneam (IL)

(21) Appl. No.: 19/043,998

(22) Filed: Feb. 3, 2025

Related U.S. Application Data
(60) Provisional application No. 63/690,085, filed on Sep. 3, 2024.

(51) Int. Cl. G02B 6/36; G02B 6/32

(52) U.S. Cl. CPC G02B 6/3652; G02B 6/325

(57) ABSTRACT

Some embodiments of the present disclosure are directed to mechanical couplers for fiber array units (FAUs) and methods of manufacturing the same. For example, an optical connector for an optical device may include an FAU and a receptacle positioned on the optical device. The FAU may include a plurality of fiber couplers (e.g., v-grooves, u-grooves, and/or the like) into which optical fibers (e.g., single mode fibers) may be positioned and held in place (e.g., using an adhesive). The FAU may be formed from a substrate, and the fiber couplers may be formed in a surface of the substrate. The FAU may also include substrate mechanical couplers (e.g., additional v-grooves, u-grooves, and/or the like) formed in the surface of the substrate adjacent the fiber couplers and extending substantially parallel to the fiber couplers on the surface of the substrate.

### CROSS-REFERENCE TO RELATED APPLICATION

The present application claims the benefit of U.S. patent application Ser. No. 63/690,085 for a “Detachable V-Groove Mounting Optical Connector” filed Sep. 3, 2024, which is hereby incorporated by reference in its entirety.

### TECHNOLOGICAL FIELD

The present disclosure is directed to mechanical couplers for fiber array units (FAUs) and methods of manufacturing the same.

### BACKGROUND

With demand for high-speed and high-volume data communication increasing, communications providers are increasingly adopting optics-based communication solutions. To meet these demands, methods of improving the manufacturing of optical elements are being developed.

### GENERAL DESCRIPTION

In one aspect, the present disclosure is directed to an optical connector including a substrate and a receptacle. The substrate may include fiber couplers formed in a surface of the substrate, where the fiber couplers extend substantially parallel to each other on the surface of the substrate, and where each of the fiber couplers is configured for receiving an optical fiber. The substrate may include substrate mechanical couplers formed in the surface of the substrate, where the substrate mechanical couplers extend substantially parallel to the fiber couplers on the surface of the substrate. The receptacle may include an optical element and receptacle mechanical couplers. Each receptacle mechanical coupler may be configured to mechanically couple with a corresponding substrate mechanical coupler, of the substrate mechanical couplers, such that the optical element optically couples an optical device and optical fibers positioned in the fiber couplers. The receptacle may be configured to detachably receive the substrate.

In some embodiments, the substrate may be an element of a fiber array unit.

In some embodiments, the optical connector may include a fiber array unit including the substrate and a pressing plate positioned on the fiber couplers. Additionally, or alternatively, the fiber array unit may include a receiving channel, and the receptacle may include a latching mechanism configured to engage the receiving channel to detachably secure the fiber array unit to the receptacle.

In some embodiments, the fiber couplers and the substrate mechanical couplers may be formed in the surface of the substrate via a same process.

In some embodiments, the fiber couplers and the substrate mechanical couplers may have a same geometry in the surface of the substrate.

In some embodiments, the fiber couplers and the substrate mechanical couplers may be selected from the group consisting of v-grooves and u-grooves.

In some embodiments, the fiber couplers and the substrate mechanical couplers may extend from a first edge of the substrate to a second edge of the substrate, opposite the first edge, across the surface of the substrate.

In some embodiments, each of the fiber couplers may be configured for receiving a single mode optical fiber.

In some embodiments, the receptacle mechanical couplers may have a complementary geometry to a geometry of the substrate mechanical couplers.

In some embodiments, the receptacle mechanical couplers may have a complementary geometry to a geometry of the fiber couplers.

In some embodiments, each substrate mechanical coupler may be configured to receive a corresponding receptacle mechanical coupler, of the receptacle mechanical couplers.

In some embodiments, when the substrate is positioned in the receptacle, the receptacle mechanical couplers may extend into the substrate mechanical couplers.

In some embodiments, the optical element may be a first optical element, and the receptacle may include a second optical element. Additionally, or alternatively, the first optical element may be configured to optically couple the second optical element and the optical fibers positioned in the fiber couplers, and the second optical element may be configured to optically couple the optical device and the first optical element. In some embodiments, the first optical element may include a mirror, and the second optical element may include a microlens array.

In some embodiments, the receptacle may be configured to detachably receive different fiber array units.

In another aspect, the present disclosure is directed to a fiber array unit including a substrate. The substrate may include fiber couplers formed in a surface of the substrate, where the fiber couplers extend substantially parallel to each other on the surface of the substrate, and where each of the fiber couplers is configured for receiving an optical fiber. The substrate may include substrate mechanical couplers formed in the surface of the substrate, wherein the substrate mechanical couplers extend substantially parallel to the fiber couplers on the surface of the substrate. Each substrate mechanical coupler may be configured to receive and mechanically couple with a corresponding receptacle mechanical coupler of a receptacle such that an optical element of the receptacle optically couples an optical device and optical fibers positioned in the fiber couplers. The fiber array unit may be configured to detachably connect to the receptacle.

In some embodiments, the fiber array unit may include a pressing plate positioned on the fiber couplers.

In some embodiments, the fiber array unit may include a receiving channel configured be engaged by a latching mechanism of the receptacle to detachably secure the fiber array unit to the receptacle.

In some embodiments, the fiber couplers and the substrate mechanical couplers may be formed in the surface of the substrate via a same process.

In some embodiments, the fiber couplers and the substrate mechanical couplers may have a same geometry in the surface of the substrate.

In some embodiments, the fiber couplers and the substrate mechanical couplers may be selected from the group consisting of v-grooves and u-grooves.

In some embodiments, the fiber couplers and the substrate mechanical couplers may extend from a first edge of the substrate to a second edge of the substrate, opposite the first edge, across the surface of the substrate.

In some embodiments, each of the fiber couplers may be configured for receiving a single mode optical fiber.

In some embodiments, the fiber couplers may have a complementary geometry to a geometry of receptacle mechanical couplers of the receptacle.

In some embodiments, when the substrate is positioned in the receptacle, receptacle mechanical couplers of the receptacle may extend into the substrate mechanical couplers.

In another aspect, the present disclosure is directed to a receptacle including a receptacle body configured to receive a fiber array unit and an optical element positioned on the receptacle body. The receptacle may include receptacle mechanical couplers positioned on the receptacle body. Each receptacle mechanical coupler may be configured to mechanically couple with a corresponding substrate mechanical coupler, of substrate mechanical couplers of the fiber array unit, such that the optical element optically couples an optical device and optical fibers positioned in the fiber array unit.

In some embodiments, the receptacle body may include glass, molded glass, silicon, plastic, or polymer.

In some embodiments, the receptacle may include a latching mechanism configured to engage a receiving channel of the fiber array unit to detachably secure the fiber array unit to the receptacle.

In some embodiments, the receptacle mechanical couplers may have a complementary geometry to a geometry of the substrate mechanical couplers.

In some embodiments, the fiber array unit may include fiber couplers formed in a surface of a substrate of the fiber array unit, where each of the fiber couplers is configured for receiving an optical fiber, and where the receptacle mechanical couplers have a complementary geometry to a geometry of the fiber couplers.

In some embodiments, when the fiber array unit is positioned in the receptacle, the receptacle mechanical couplers may extend into the substrate mechanical couplers.

In some embodiments, the optical element is a first optical element, and the receptacle may include a second optical element. Additionally, or alternatively, the first optical element may be configured to optically couple the second optical element and the optical fibers positioned in the fiber array unit, and the second optical element may be configured to optically couple the optical device and the first optical element. In some embodiments, the first optical element may include a mirror, and the second optical element may include a microlens array.

In some embodiments, the receptacle may be configured to detachably receive different fiber array units.

In another aspect, the present disclosure is directed to a method of manufacturing an optical connector. The method may include forming fiber couplers in a surface of a substrate of a fiber array unit such that the fiber couplers extend substantially parallel to each other on the surface of the substrate and such that each of the fiber couplers is configured for receiving an optical fiber. The method may include forming substrate mechanical couplers in the surface of the substrate such that the substrate mechanical couplers extend substantially parallel to the fiber couplers on the surface of the substrate. The method may include providing an optical element on a receptacle body of a receptacle. The method may include forming receptacle mechanical couplers on the receptacle body such that each receptacle mechanical coupler is configured to mechanically couple with a corresponding substrate mechanical coupler, of the substrate mechanical couplers, and such that the optical element optically couples an optical device and optical fibers positioned in the fiber couplers when the fiber array unit is positioned in the receptacle.

In some embodiments, the method may include, when forming the fiber couplers in the surface of the substrate and when forming the substrate mechanical couplers in the surface of the substrate, forming the fiber couplers and forming the substrate mechanical couplers to have a same depth below the surface of the substrate.

In some embodiments, forming the fiber couplers in the surface of the substrate may include using a process to form the fiber couplers in the surface of the substrate, and forming the substrate mechanical couplers in the surface of the substrate may include using the same process to form the substrate mechanical couplers in the surface of the substrate. Additionally, or alternatively, the process may include mechanically etching the substrate to form the fiber couplers and the substrate mechanical couplers. In some embodiments, mechanically etching may include using a dicing saw with a blade to form the fiber couplers and the substrate mechanical couplers. Additionally, or alternatively, the process may include chemically etching the substrate to form the fiber couplers and the substrate mechanical couplers. In some embodiments, forming the fiber couplers in the surface of the substrate and forming the substrate mechanical couplers in the surface of the substrate may be performed simultaneously.

In some embodiments, the method may include positioning one or more optical-fiber ends of one or more optical fibers in one or more fiber couplers of the fiber couplers and applying adhesive to a portion of the substrate, the one or more optical-fiber ends, and the one or more fiber couplers. Additionally, or alternatively, the method may include positioning a pressing plate of the fiber array unit on the adhesive, the portion of the substrate, and the one or more optical-fiber ends and applying pressure to the pressing plate to position the one or more optical-fiber ends in the one or more fiber couplers of the portion of the substrate.

In some embodiments, the method may include forming a receiving channel on the fiber array unit and forming a latching mechanism on the receptacle such that, when the fiber array unit is positioned on the receptacle, the latching mechanism engages the receiving channel to detachably secure the fiber array unit to the receptacle.

In some embodiments, the optical element may be a first optical element, and the method may include forming a second optical element such that (i) the first optical element optically couples the second optical element and the optical fibers positioned in the fiber couplers and (ii) the second optical element optically couples the optical device and the first optical element.

In some embodiments, the method may include securing the receptacle to an optical device and positioning the fiber array unit in the receptacle.

In another aspect, the present disclosure is directed to a method of manufacturing a fiber array unit. The method may include forming fiber couplers in a surface of a substrate of a fiber array unit such that the fiber couplers extend substantially parallel to each other on the surface of the substrate and such that each of the fiber couplers is configured for receiving an optical fiber. The method may include forming substrate mechanical couplers in the surface of the substrate such that (i) the substrate mechanical couplers extend substantially parallel to the fiber couplers on the surface of the substrate and (ii) each substrate mechanical coupler, of the substrate mechanical couplers, is configured to mechanically couple with a corresponding receptacle mechanical coupler to optically couple an optical device and optical fibers positioned in the fiber couplers when the fiber array unit is positioned in a receptacle.

In some embodiments, the method may include, when forming the fiber couplers in the surface of the substrate and when forming the substrate mechanical couplers in the surface of the substrate, forming the fiber couplers and forming the substrate mechanical couplers to have a same depth below the surface of the substrate.

In some embodiments, forming the fiber couplers in the surface of the substrate may include using a process to form the fiber couplers in the surface of the substrate, and forming the substrate mechanical couplers in the surface of the substrate may include using the same process to form the substrate mechanical couplers in the surface of the substrate. Additionally, or alternatively, the process may include mechanically etching the substrate to form the fiber couplers and the substrate mechanical couplers. In some embodiments, mechanically etching may include using a dicing saw with a blade to form the fiber couplers and the substrate mechanical couplers. Additionally, or alternatively, the process may include chemically etching the substrate to form the fiber couplers and the substrate mechanical couplers. In some embodiments, forming the fiber couplers in the surface of the substrate and forming the substrate mechanical couplers in the surface of the substrate may be performed simultaneously.

In some embodiments, the method may include positioning one or more optical-fiber ends of one or more optical fibers in one or more fiber couplers of the fiber couplers and applying adhesive to a portion of the substrate, the one or more optical-fiber ends, and the one or more fiber couplers. The method may include positioning a pressing plate of the fiber array unit on the adhesive, the portion of the substrate, and the one or more optical-fiber ends and applying pressure to the pressing plate to position the one or more optical-fiber ends in the one or more fiber couplers of the portion of the substrate.

In some embodiments, the method may include forming a receiving channel on the fiber array unit such that, when the fiber array unit is positioned on the receptacle, the receiving channel is configured to be engaged by a latching mechanism on the receptacle to detachably secure the fiber array unit to the receptacle.

In some embodiments, the method may include positioning the fiber array unit in the receptacle while the receptacle is secured to the optical device.

In another aspect, the present disclosure is directed to a method of manufacturing a receptacle. The method may include providing an optical element on a receptacle body of a receptacle. The method may include forming receptacle mechanical couplers on the receptacle body such that each receptacle mechanical coupler is configured to mechanically couple with a corresponding substrate mechanical coupler, of substrate mechanical couplers of a fiber array unit, and such that the optical element optically couples an optical device and optical fibers positioned in fiber couplers of the fiber array unit when the fiber array unit is positioned in the receptacle.

In some embodiments, the method may include forming a latching mechanism on the receptacle such that, when the fiber array unit is positioned on the receptacle, the latching mechanism engages a receiving channel of the fiber array unit to detachably secure the fiber array unit to the receptacle.

In some embodiments, the optical element is a first optical element, and the method may include forming a second optical element such that (i) the first optical element optically couples the second optical element and the optical fibers positioned in the fiber couplers and (ii) the second optical element optically couples the optical device and the first optical element.

In some embodiments, the method may include securing the receptacle to an optical device and positioning the fiber array unit in the receptacle.

The features, functions, and advantages that have been discussed may be achieved independently in various embodiments of the present disclosure or may be combined with yet other embodiments, further details of which may be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 illustrates an example network architecture, in accordance with an embodiment of the disclosure;

FIG. 2 illustrates an example datacenter network topology, in accordance with an embodiment of the disclosure;

FIG. 3 is a schematic, partially exploded, perspective view of an electronic module, in accordance with an embodiment of the disclosure;

FIG. 4A schematically depicts a perspective view of an optical connector of an optical device, in accordance with an embodiment of the disclosure;

FIG. 4B schematically depicts a close-up, perspective view of the optical connector of FIG. 4A;

FIG. 4C depicts a cross-sectional side view of the optical connector and the optical device of FIG. 4A;

FIG. 4D schematically depicts a perspective view of an FAU of the optical connector of FIG. 4A;

FIG. 4E depicts a cross-sectional front view of the FAU of FIG. 4D;

FIG. 5 is a block diagram that schematically illustrates a co-packaged Networking Device, in accordance with an embodiment of the disclosure;

FIG. 6 illustrates a schematic block diagram of example circuitry, in accordance with an embodiment of the disclosure;

FIG. 7 illustrates a computer system, in accordance with an embodiment of the disclosure;

FIG. 8 is a block diagram that schematically illustrates a computing system, in accordance with an embodiment of the disclosure;

FIG. 9 is a flowchart illustrating a method of manufacturing an optical connector, in accordance with an embodiment of the present disclosure;

FIG. 10 is a flowchart illustrating a method of manufacturing an FAU, in accordance with an embodiment of the present disclosure;

FIG. 11 is a flowchart illustrating a method of manufacturing a receptacle, in accordance with an embodiment of the present disclosure.

### DETAILED DESCRIPTION OF EMBODIMENTS

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Furthermore, when it is said herein that something is “based on” something else, it may be based on one or more other things as well. In other words, unless expressly indicated otherwise, as used herein “based on” means “based at least in part on” or “based at least partially on.” Also, as used herein, the term “or” is intended to be inclusive when used in a series and may be used interchangeably with “and/or,” unless explicitly stated otherwise (e.g., if used in combination with “either” or “only one of”). Like numbers refer to like elements throughout. No element, act, or instruction used herein should be construed as critical or essential unless explicitly described as such.

As used herein, “operatively coupled” may mean that the components are electronically or optically coupled and/or are in electrical or optical communication with one another. Furthermore, “operatively coupled” may mean that the components may be formed integrally with each other or may be formed separately and coupled together. Furthermore, “operatively coupled” may mean that the components may be directly connected to each other or may be connected to each other with one or more components (e.g., connectors) located between the components that are operatively coupled together. Furthermore, “operatively coupled” may mean that the components are detachable from each other or that they are permanently coupled together.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

Furthermore, as would be evident to one of ordinary skill in the art in light of the present disclosure, the terms “substantially” and “approximately” indicate that the referenced element or associated description is accurate to within applicable engineering tolerances.

Silicon Photonics (SiP) is a technology that enables optical systems to be manufactured using silicon processes with silicon as the optical medium. Various optical components, such as interconnects and signal processing components, may be fabricated and integrated in a single SiP device. Some SiP devices are fabricated on a silica substrate or over a silica layer on a silicon substrate, a technology that is often referred to as Silicon on Insulator (SOI). In certain optical systems, a SiP device is attached to an external device to facilitate optical communications. However, it is generally difficult to accurately align light signals on the SiP with an external device that receives the light.

In certain optical systems, a SiP device is attached to an external device to facilitate optical communications. However, it is generally difficult to accurately align light signals on the SiP with an external device that receives the light. For instance, long range transmission of light signals is generally performed within optical fibers. When optical signals are generated or processed in a SiP device for transmission over optical fibers, the light needs to be coupled between the SiP device and the optical fibers. This coupling between the SiP device and the optical fibers is generally difficult because waveguides within the SiP device generally comprise a smaller diameter than the optical fibers. As such, a “world-to-chip” interface problem often arises in SiP technologies where coupling of light between Si wire waveguides and optical fibers, and vice versa, is generally inefficient.

Traditionally, for fiber-to-chip coupling, a fiber coupling technique using spot-size converters (SSCs) or grating couplers is employed. However, grating couplers for fiber-to-chip coupling typically provide a narrow bandwidth and/or an undesirable polarization sensitivity for certain optical applications. Furthermore, SSCs and grating couplers for fiber-to-chip coupling are generally attached to the chip through an adhesive bonding technique that results in a silicon communication chip with bundles of fibers attached thereto, resulting in increased complexity for handling and/or assembly of the chips onto other optical systems. Additionally, wafers for traditional SiP devices are generally diced (e.g., fully cut through) to create an edge for the wafer to expose waveguide facets and/or to facilitate butt attachment of the SiP device to an external device.

The present disclosure is directed to mechanical couplers for FAUs and methods of manufacturing the same. An optical connector may include a receptacle attached to an optical device (e.g., a vertical-cavity surface-emitting laser (VCSEL), LED, EML, DML, a SiP device, a photodetector, and/or the like) and an FAU including an array of optical fibers, where the receptacle is configured to receive the fiber array unit such that optical inputs and/or outputs of the optical device can be transmitted to and/or from the optical fibers via the optical connector. Such optical connectors have a pivotal role in co-packaged optics (CPO) packages. A CPO package may integrate photonic high-speed optical interconnect components with one or more functional switch application-specific integrated circuits (ASICs), graphics processing units (GPUs), central processing units (CPUs), data processing units (DPUs), quantum processing units (QPUs), a plurality of parallel processing units (PPUs), microprocessors, field-programmable gate arrays (FPGAs), logic gates, transistors, resistors, capacitors, inductors, diodes, switches (e.g., high-speed network switches), network adapters, memory devices, input/output (I/O) devices, peripheral devices, components on a system-on-chip (SoC), and/or the like on a common substrate. By using CPO systems, computing systems may significantly reduce cost and power consumption over current systems.

Current methods of manufacturing CPO packages involve optical connectors that require active alignment or mechanical alignment features in order to transmit optical signals properly. Active alignment is a process that involves receiving optical feedback for alignment by positioning optical elements, as optical devices are being assembled, to ensure precision and/or accuracy of optical signal transmission. Performing active alignment increases production cost and time. Furthermore, individually aligning each optical device entails a higher susceptibility to variance in the assemblies. For optical connectors that use mechanical alignment features, the receptacle and the fiber array unit must be precisely matched to each other in order to achieve the sub-micron accuracy required when attaching single mode fibers to a single mode optical device. Furthermore, only the precisely matched fiber array unit may be used with its matching receptacle such that there is no interchangeability. Finally, whether using active alignment or mechanical alignment features, the fiber array unit must be permanently adhered to the receptacle using adhesive, which makes servicing or replacing the optical device expensive and time-consuming.

Detachable optical connection of fibers to die is required for operative consideration like device replacement and services. The present disclosure provides a detachable mechanism that allows accurate positioning (location and mating) of the optical connector related to an optical source with minimum tolerances.

The present disclosure is directed to mechanical couplers for detachably connecting FAUs and receptacles. An optical connector for an optical device may include an FAU and a receptacle positioned on the optical device. The FAU may include a plurality of fiber couplers (e.g., v-grooves, u-grooves, and/or the like) into which optical fibers (e.g., single mode fibers, multi-mode fibers, and/or the like) may be positioned and held in place (e.g., using an adhesive). The FAU may be formed from a substrate, and the fiber couplers may be formed in a surface of the substrate (e.g., using a beveled blade with a dicing saw machine, by chemical etching of the substrate, and/or the like). The fiber couplers may extend substantially parallel to each other on the surface of the substrate. The FAU may also include substrate mechanical couplers (e.g., additional v-grooves, u-grooves, and/or the like) formed in the surface of the substrate adjacent the fiber couplers and extending substantially parallel to the fiber couplers on the surface of the substrate. The substrate mechanical couplers may be formed in the substrate using the same process used to form the fiber couplers.

The receptacle may include a microlens array and an optical element (e.g., a folding mirror, a curved mirror, and/or the like), where the microlens array and the optical element are configured to optically couple the optical device with optical fibers in the fiber couplers. The receptacle may also include mechanical couplers configured to mechanically couple with the substrate mechanical couplers of the FAU such that, when the FAU is connected to the receptacle, the optical fibers of the FAU are aligned with the optical element of the receptacle.

By forming the substrate mechanical couplers using the same process as used to form the fiber couplers, any inaccuracy in the depth of the fiber couplers will also exist in the substrate mechanical couplers. Thus, depth-wise positional differences of optical fibers in different FAUs due to inaccuracies in depths of fiber couplers may be compensated for by the substrate mechanical couplers when positioned in the receptacle, and the optical fibers of the FAUs may be accurately aligned with the optical element of the receptacle. Furthermore, because the substrate mechanical couplers compensate for the depth-wise positional differences of optical fibers in different FAUs, the receptacle can be configured to detachably receive different FAUs, thereby achieving a detachable connector that precisely aligns optical fibers (e.g., to a tolerance of less than a micron). The present disclosure is also directed to methods of manufacturing such FAUs and receptacles.

### Example Network Architecture

Datacenters and other networking systems may include connections between datacenters, switch systems, servers, racks, and devices in order to provide for signal transmission between one or more of these elements. These connections may be made using cables, transceivers, interconnects, interposers, and connector assemblies. For high bandwidth applications and/or connections over long distances, high powered optical communications may be preferred to ensure signal transmission integrity.

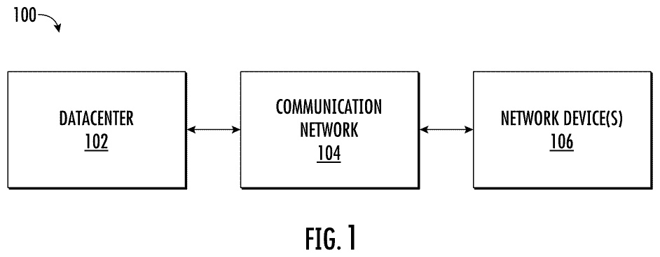

FIG. 1 illustrates an example network architecture 100, in accordance with an embodiment of the disclosure. As shown in FIG. 1, the network architecture 100 may include a datacenter 102, a communication network 104, and network device(s) 112. It is to be understood that the network architecture 100 may depict the general computing architecture within which more specific systems and/or subsystems may function. The network architecture 100 may provide a broad, abstract representation of the overall infrastructure, allowing for the inclusion of various configurations and implementations of the individual components without limiting the scope of the disclosure.

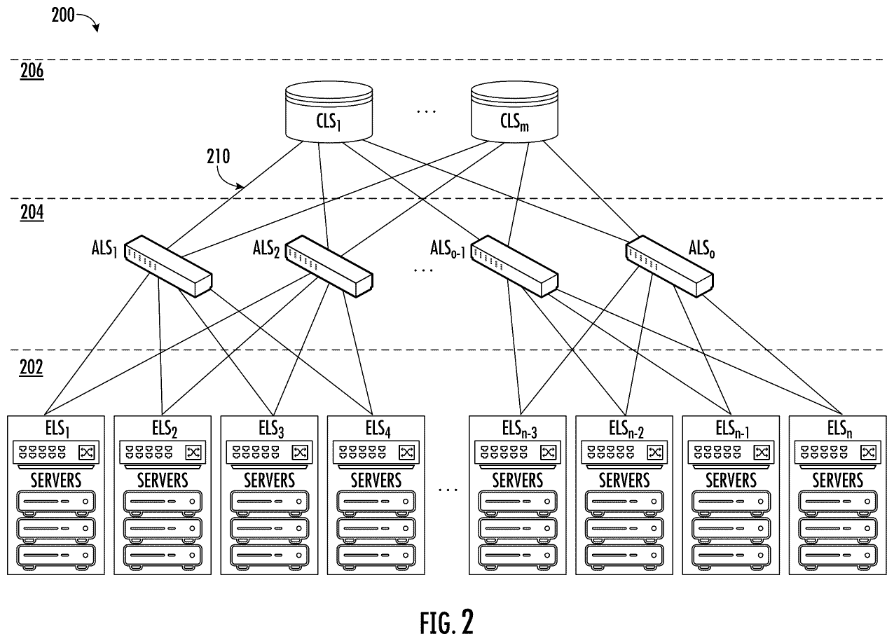

The datacenter 102 may be a centralized facility designed to house computing resources and related components. The primary function of the datacenter 102 may be to support the infrastructure required for advanced computational tasks, for efficient, secure, and reliable operations. The datacenter 102 may include building and structural components, including power supplies, cooling systems, fire suppression systems, and physical security measures that are configured to maintain optimal operating conditions and protect the equipment from environmental hazards and unauthorized access. At its core, the datacenter 102 may include high-performance servers or compute nodes, often arranged in racks, and connected through high-speed networks, as described in more detail in FIG. 2. These servers may include processors (e.g., central processing units (CPUs), graphics processing units (GPUs), a DPU, a QPU or a PPU and/or the like), memory (e.g., RAM), and storage solutions (e.g., hard disk drives (HDDs), solid state drives (SSDs), and/or the like). QPUs may be configured to perform one or more operations associated with a quantum algorithm. In some embodiments, each of the one or more QPUs may include a plurality of qubits and the one or more QPUs may be in communication with each other via a quantum channel. Additionally, or alternatively, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with. The hardware configuration may be optimized for parallel processing and high throughput, catering to the demands of high-performance computing (HPC) applications.

The datacenter 102 may include high-speed network equipment, such as network switches, routers, firewalls, and/or the like to facilitate fast and secure data transmission within the datacenter 102 (e.g., between the servers or compute nodes) and between external networks. The datacenter 102 may facilitate communication between servers or compute nodes through a network topology that ensures efficient data exchange, minimizes latency, and maximizes bandwidth. The network topology may dictate how various network devices, such as switches and routers, are interconnected for data flow. By implementing an effective network topology, the datacenter 102 can support high-performance computing tasks. Examples of various network topologies may include hierarchical networking topologies such as the fat tree topology, Slim Fly topology, Dragonfly topology, and/or the like.

The communication network 104 may operatively couple the datacenter 102 to network device(s) 108 and other external devices for data exchange and connectivity. Examples of communication network 104 may include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. Each type of network offers specific advantages tailored to different operational requirements. For instance, an IP network or Ethernet network may provide widespread compatibility and ease of integration, supporting various protocols and applications across the datacenter 102 and the network device(s) 108 (and/or external devices). An InfiniBand network may offer high throughput and low latency, ideal for HPC environments where rapid data transfer and minimal delay are required. Fibre Channel networks may be employed for their robust performance in storage area networks (SANs), ensuring fast and reliable access to storage resources. Cellular and wireless communication networks may be used to extend connectivity to remote and/or mobile devices for increased flexibility and/or accessibility. The ability of the communication network 104 to incorporate multiple network types and/or configurations allows the datacenter 102 to adapt to diverse application needs, from general data communication to specialized HPC tasks.

The network device(s) 108 may include a variety of computing devices capable of transmitting and receiving signals over the communication network 104. The network device(s) 108 may range from personal computing devices to complex server configurations. Examples include Personal Computers (PCs), laptops, tablets, smartphones, servers, and/or the like. The network device(s) 108 may facilitate user interactions with the datacenter 102, allowing for data input, retrieval, and/or processing from remote locations. In addition to individual computing devices, the network device(s) 108 may also include collections of servers and/or additional datacenters. For instance, these could be other datacenters similar to or the same as datacenter 102. Such an interconnection may allow for the formation of a distributed computing environment for improved redundancy, load balancing, and/or disaster recovery capabilities. By linking multiple datacenters, the network architecture 100 can leverage geographically dispersed resources, optimizing performance and/or ensuring high availability.

As described herein, the datacenter 102 and/or the network device(s) 108 may include storage devices and processing circuitry for executing computing tasks, such as controlling the flow of data internally and over the communication network 104. The processing circuitry may include software, hardware, or a combination thereof. For example, the processing circuitry may include a memory containing executable instructions and a processor (e.g., a microprocessor) that executes these instructions. The memory may correspond to any suitable type of memory device or collection of memory devices configured to store instructions. Non-limiting examples of suitable memory devices include Flash memory, Random Access Memory (RAM), Read Only Memory (ROM), variants thereof, combinations thereof, or similar technologies. In specific embodiments, the memory and processor may be integrated into a common device, such as a microprocessor with integrated memory. Additionally, or alternatively, the processing circuitry may comprise hardware components, such as an application-specific integrated circuit (ASIC). Other non-limiting examples of processing circuitry include Integrated Circuit (IC) chips, CPUs, GPUs, DPUs, QPUs, PPUs, microprocessors, Field-Programmable Gate Arrays (FPGAs), collections of logic gates or transistors, resistors, capacitors, inductors, and/or diodes. Some or all of the processing circuitry may be provided on a Printed Circuit Board (PCB) or a collection of PCBs. It should be appreciated that any appropriate type of electrical component or collection of electrical components may be suitable for inclusion in the processing circuitry.

In addition, although not explicitly shown, it should be appreciated that the datacenter 102 and network device(s) 108 may include one or more communication interfaces for facilitating wired and/or wireless communication between one another and other unillustrated elements of the network architecture 100. These communication interfaces may include a variety of technologies, including but not limited to Ethernet ports, fiber optic connections, Wi-Fi® transceivers, Bluetooth® modules, and cellular communication modules for integration and interoperability among the various components within the network architecture 100.

Furthermore, it should be understood that the network architecture 100 may include additional components and functionalities within the scope of the present disclosure. These components may comprise, without limitation, additional processing units, specialized accelerators (such as Tensor Processing Units or TPUs), enhanced security modules, and/or redundant power supplies. The inclusion of these elements is intended to ensure that the network architecture 100 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the network architecture 100.

### Example Network Topology of the Network Architecture

FIG. 2 illustrates an example datacenter network topology 200, in accordance with an embodiment of the disclosure. As shown in FIG. 2, the example datacenter network topology 200 is exemplified using a fat tree topology. However, it is to be understood that the fat tree topology merely serves as a representative model to describe the datacenter network architecture. Other network topologies may also be contemplated within the scope of the disclosure. Examples of such alternative topologies include, but are not limited to, Slim Fly topology, which is designed to reduce the number of hops and cable lengths between nodes; Dragonfly topology, which aims to enhance network scalability and reduce latency through a hierarchical group of interconnected switches; and other hierarchical or non-hierarchical topologies that may be optimized for specific performance, scalability, and/or cost considerations. The principles and innovations disclosed herein can be applied to these and other network topologies to achieve similar advantages and benefits. Any modifications, variations, or adaptations of the network topologies that fall within the spirit and scope of the present disclosure are considered to be encompassed by this disclosure.

As shown in FIG. 2, the example datacenter network topology 200 may include three distinct layers: the edge layer 202, the aggregation layer 204, and the core layer 206. The edge layer 202, located at the bottom of the hierarchy, may incorporate Top-of-Rack (ToR) switches ELS₁, ELS₂, . . . , ELSₙ. The edge layer 202 may serve as the initial point of aggregation for traffic originating from the servers operatively coupled to the ToR switches ELS₁, ELS₂, . . . , ELSₙ in the edge layer 202. Each ToR switch may connect multiple servers within a rack, consolidating data traffic from those servers and forwarding it to the higher layers of the network. The edge layer 202 may be responsible for handling east-west traffic within the datacenter, facilitating efficient data exchange between servers located in different racks.

The aggregation layer 204 may be positioned above the edge layer 202 and may further consolidate traffic from multiple ToR switches. In one embodiment, the aggregation layer 204 may include switches ALS₁, ALS₂, . . . , ALSₒ that are configured to receive data traffic from the ToR switches in the edge layer 202. These aggregation switches may aggregate traffic and manage load balancing, ensuring that data flows efficiently between the edge layer 202 and the core layer 206. The aggregation layer 204 may also provide redundancy and fault tolerance, allowing data traffic to be rerouted in case of failures in the network.

At the top of the hierarchy, the core layer 206 may include high-speed switches CLS₁, CLS₂, . . . , CLSₘ. The core layer 206 may serve as the backbone of the datacenter network, providing high-speed interconnectivity between the switches of the aggregation layer 204 and ensuring data can traverse the network quickly and efficiently. The core layer 206 may be responsible for managing north-south traffic, enabling communication between the datacenter and external networks or between different datacenters. In some embodiments, the core layer 206 may support multiple data paths and implement advanced routing protocols to optimize data transmission across long distances or between different geographic locations.

The datacenter network topology 200 may be configured to support high bandwidth and low-latency communication, enabling efficient handling of large-scale data transfers and computational tasks. By implementing a hierarchical network structure, with the edge layer 202, aggregation layer 204, and core layer 206, the datacenter network topology 200 may facilitate scalable and resilient network performance, accommodating the increasing demands of modern high-performance computing and cloud-based applications. As described herein, various network topologies, such as fat tree, Slim Fly, or Dragonfly topologies, may be implemented within this layered structure, depending on the specific requirements of the datacenter infrastructure.

Furthermore, the interconnections between the layers (e.g., edge layer 202, aggregation layer 204, and core layer 206) may be established using high-speed networking technologies such as Ethernet, InfiniBand, or optical fiber, depending on the required data transfer rates and latency considerations. Each layer in the datacenter network topology 200 may be optimized to handle specific types of traffic and ensure smooth communication across the network, providing flexibility and scalability in various operational scenarios.

The switches (e.g., CLS₁₋ₘ, ALS₁₋ₒ, and ELS₁₋ₙ) within each layer may be 1U switches, where “1U” refers to the industry-standard size for rack-mounted switches and servers. The switches may be electrical switches, optical switches, hybrid electro-optical switches, or any combination thereof. Each type of switch may include suitable hardware and/or software for routing signals within its respective domain.

An electrical switch may be configured to receive and route optical signals by first converting them into electrical signals. The conversion process may involve receivers that include components such as a transimpedance amplifier (TIA), a photodetector, and a controller, all of which work together to convert incoming optical signals into electrical signals. Once converted, the electrical signals may be routed through the internal circuitry of the switch. The electrical switch may also include transmitters that convert the routed electrical signals back into optical signals for transmission to another switch (either optical or electrical) within the network. These transmitters may include a light source, a modulator, and a controller to manage the modulator and light source. In some embodiments, the receiver and transmitter functions may be combined into a single transceiver to streamline signal conversion and transmission.

An optical switch, by contrast, routes optical signals directly without converting them into electrical form. The optical switch may include optical receivers, such as photodetectors and wavelength-division multiplexing (WDM) demultiplexers, to receive and manage incoming optical signals. These signals may then be routed through internal optical switching components, such as micro-electromechanical systems (MEMS) mirrors, waveguides, or optical cross-connects, which guide the signals to their appropriate output paths. The optical switch may further include optical transmitters, such as laser diodes and modulators, which transmit the routed optical signals to the next switch in the network.

The interconnections 210 between the switches within the network topology may be implemented using optical fibers and/or traditional electrical cables, depending on the specific requirements of the system. The interconnections 210 may serve as communication lanes, which may be constructed of dedicated differential cable pairs and/or fiber optics, with each option tailored to meet the performance demands of data transmission.

Dedicated differential cable pairs used in these interconnections may be composed of a variety of cable media, including copper, aluminum, gold, silver, nickel, or composite materials such as copper-clad aluminum, copper-clad steel, or bimetallic conductors. These materials may be selected based on their electrical conductivity and durability, ensuring reliable and efficient data transmission. In some implementations, a four-lane network may be employed, where each lane consists of its own dedicated copper cable, thereby providing isolated physical paths for each communication lane of a deserialized data stream, which helps maintain signal integrity and reduce crosstalk between the lanes.

Alternatively, fiber optic cables may be employed for the interconnections. Fiber optics are capable of transmitting data streams via different wavelengths of light, with each data stream assigned a unique wavelength. The use of fiber optic cables may allow multiple data streams to be transmitted simultaneously through a single fiber optic cable, significantly increasing the bandwidth and efficiency of the network, and particularly advantageous for long-distance data transmission and for applications requiring high data transfer rates. Various optical networking technologies, such as Time Division Multiplexing (TDM), Frequency Division Multiplexing (FDM), or Wavelength Division Multiplexing (WDM), can be used to transmit multiple optical signals (e.g., data signals or data streams) over a single optical fiber within an optical link with little to no optical signal interference. These optical networking technologies may be used to improve bandwidth efficiency and reduce the amount of infrastructure needed for data communication. In TDM, multiple optical signals can be transmitted over a single optical fiber by assigning each optical signal a respective time slot and transmitting an optical signal during its assigned time slot; in FDM, multiple optical signals can be transmitted over a single optical fiber by assigning each optical signal a respective frequency band; and in WDM, multiple optical signals having different wavelengths are combined into a single optical signal and transmitted over a single optical fiber.

### Example Electronic Module

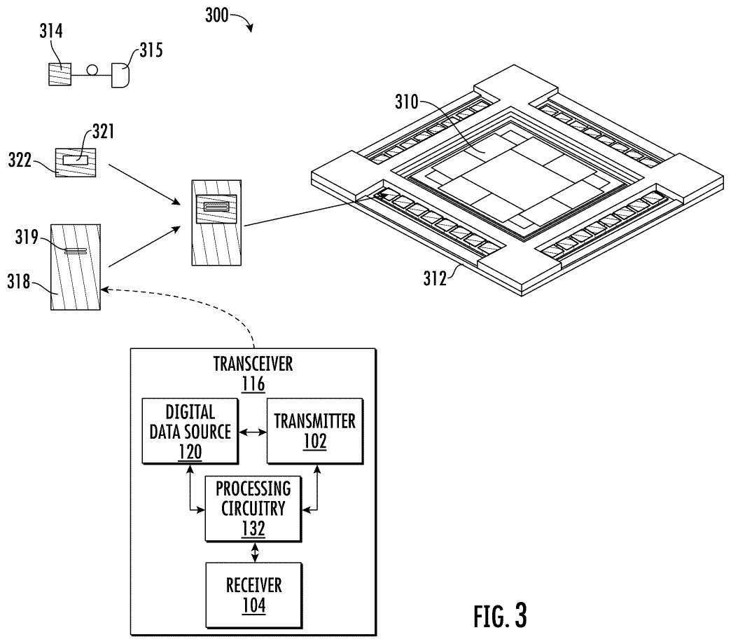

FIG. 3 is a schematic, partially exploded, perspective view of an electronic module 300 (e.g., an electronic device, a CPO package, a chip-on-wafer device, a silicon photonic IC, a photonic wafer, and/or the like). The electronic module 300 may be configured to operate within or in conjunction with a broader network architecture (e.g., network architecture 100). Various components of the electronic module 300 described herein may interact with the network architecture 100 to facilitate communication, data processing, and overall system management. In particular, the electronic module 300 may leverage the underlying network topology (e.g., datacenter network topology 200) for efficient data transmission, whether through high-speed interconnections or optimized routing protocols.

As shown in FIG. 3, the electronic module 300 may include a substrate 312, a chip-on-wafer 310 (e.g., a main die), and at least one optical device depicted as photonic IC 318 (e.g., a chip containing a plurality of photonic components that may form a functioning circuit and/or that may generate, transmit, detect, and/or process light). The substrate 312, for example, may be a printed circuit board, a metal carrier, an organic carrier, and/or a ceramic carrier. For example, the photonic IC 318 may be an electro-optic modulator, a photodiode, a transmitter optical sub-assembly and/or a receiver optical sub-assembly. As will be appreciated by those of ordinary skill in the art in view of this disclosure, the photonic IC 318 is an example of an optical device with which mechanical couplers for detachably connecting FAUs and receptacles of the present disclosure may be used. Other exemplary optical devices may include surface emitting/absorbing electro-optics devices such as VCSELs, SiP devices (e.g. grating coupler), photodetectors, and/or the like.

As also shown in FIG. 3, the chip-on-wafer 310 may be positioned on a central portion of the substrate 312, and the photonic IC 318 may be positioned on a peripheral portion of the substrate 312. As will be appreciated by those of ordinary skill in the art in view of this disclosure, a representative photonic IC 318 is depicted on the left side of FIG. 3 as being representative of the photonic IC 318 on the peripheral portion of the substrate 312.

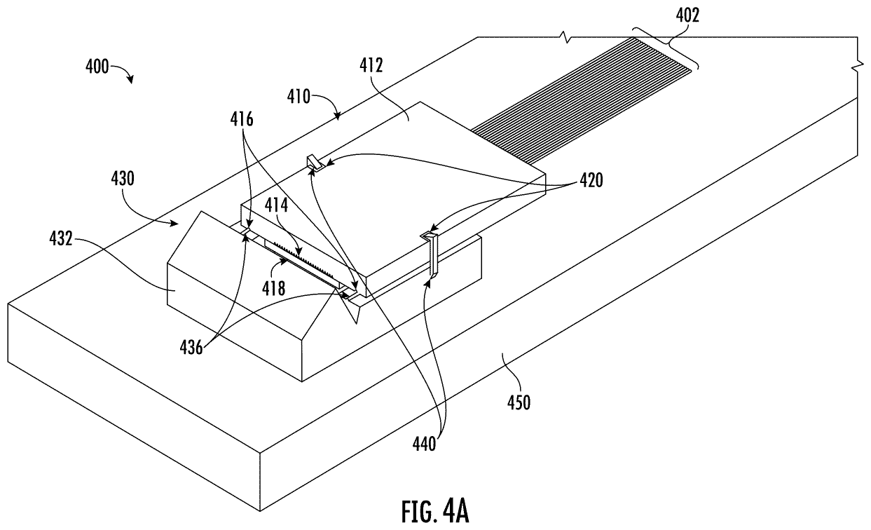

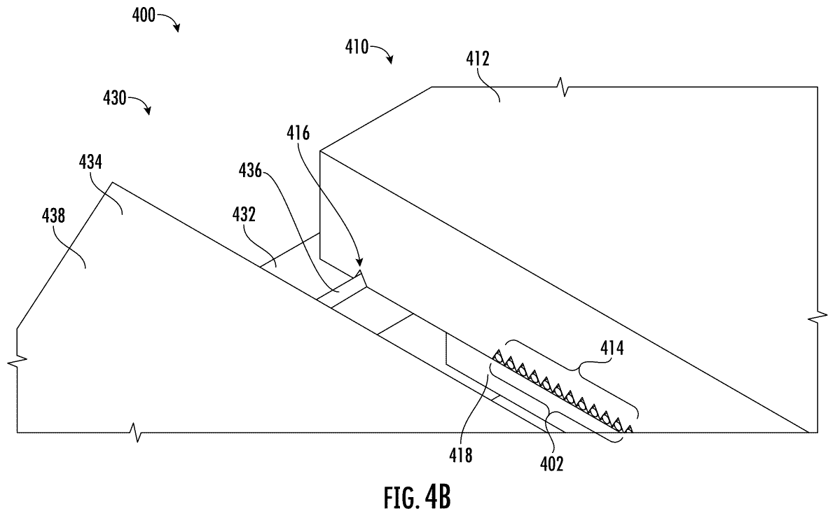

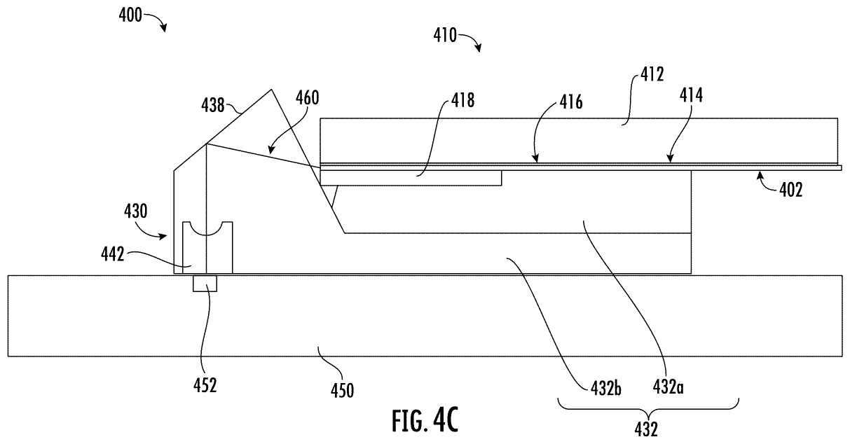

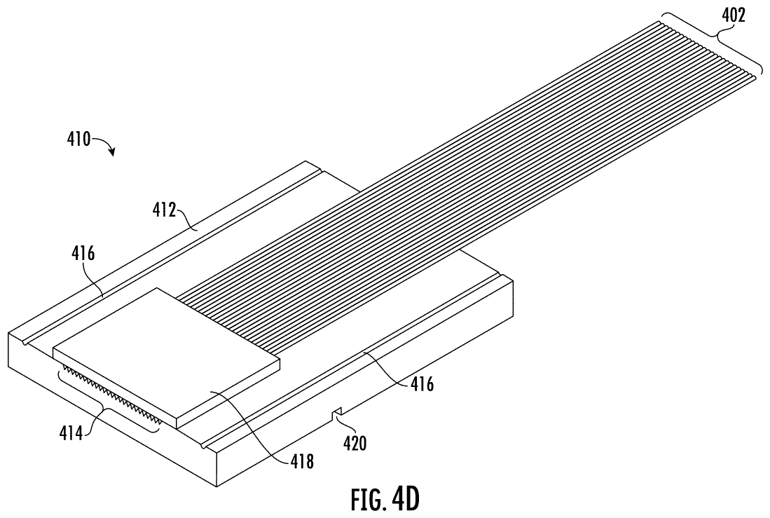

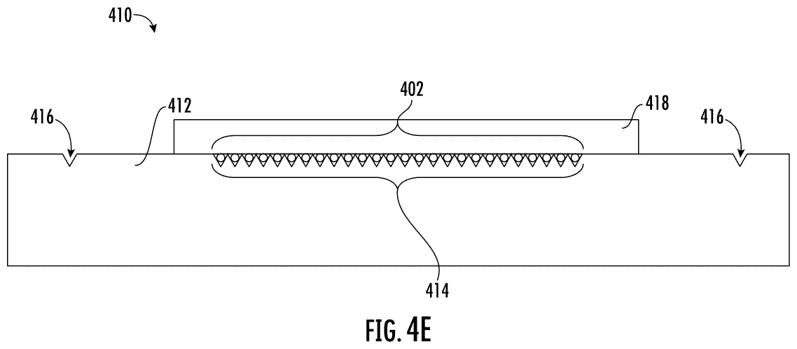

As shown in FIG. 3, a receptacle 322 (e.g., similar to a receptacle 430 shown and described herein with respect to FIGS. 4A-4E) including an optical window 321 may be positioned on each of the photonic ICs 318, and each receptacle 322 may be configured to align its optical window 321 and a corresponding detachable connector 314 (e.g., including an FAU) with an optical window 319 of a corresponding photonic IC 318. In some embodiments, the corresponding photonic IC 318 may be a photonics transceiver module for sending and receiving signals, for example, data signals. The transceiver 316 may be connected to a node, such as a server. The data signals may be digital or optical signals modulated with data or other suitable signals for carrying data. The transceiver 316 may include a digital data source 320, a transmitter 302, a receiver 304, and processing circuitry 332 that controls the transceiver 316. The digital data source 320 may include suitable hardware and/or software for outputting data in a digital format (e.g., in binary code and/or thermometer code). The digital data output by the digital data source 320 may be retrieved from memory (not illustrated) or generated according to input (e.g., user input). The transceiver 316 or selected elements of the transceiver 316 may take the form of a pluggable component or controller for the chip-on-wafer 310. For example, the transceiver 316 or selected elements of the transceiver 316 may be implemented on a network interface controller (NIC).

In some embodiments, the receptacle 322 may be bonded and actively aligned to the photonic IC 318 to form a SiP with receptacle stack during manufacturing. The detachable connectors 314 may be connected via optical fibers to an optical connector 315 (e.g., an MPO connector and/or the like), which are in optical communication with one or more optical devices (not pictured). In this way, the receptacles 322 and the detachable connectors 314 optically connect the photonic ICs 318 of the electronic module 300 to one or more optical devices.

In some embodiments, one or more of the photonic ICs 318 may be configured to receive electrical signals from the chip-on-wafer 310 (e.g., via electrical traces through the substrate 312), convert the electrical signals to optical signals, and transmit the optical signals to one or more optical devices. Additionally, or alternatively, one or more of the photonic ICs may be configured to receive optical signals from one or more optical devices, convert the optical signals to electrical signals, and transmit the electrical signals to the chip-on-wafer 310 (e.g., via electrical traces through the substrate 312).

### Example Optical Connector

FIGS. 4A-4E schematically depict elements of an optical connector 400 of an optical device 450, in accordance with an embodiment of the disclosure. In particular, FIG. 4A schematically depicts a perspective view of the optical connector 400 on the optical device 450, and FIG. 4B schematically depicts a close-up, perspective view of the optical connector 400. FIG. 4C depicts a cross-sectional side view of the optical connector 400 and the optical device 450, and FIG. 4D schematically depicts a perspective view of an FAU 410 of the optical connector 400. Finally, FIG. 4E depicts a cross-sectional front view of the FAU 410.

As shown in FIGS. 4A-4C, the optical connector 400 may include the FAU 410 and a receptacle 430, where the receptacle is positioned on the optical device 450. The FAU 410 and the receptacle 430 may be configured such that the receptacle 430 may detachably receive the FAU 410 and both mechanically and optically couple optical fibers 402 positioned in the FAU 410 to the optical device 450. In particular, and as described further herein, the FAU 410 and the receptacle 430 may be configured to precisely mechanically align with each other such that the optical fibers 402 are precisely optically aligned with an optical window 452 of the optical device 450 (See FIG. 4C).

The FAU 410 may include a substrate 412, one or more fiber couplers 414, one or more substrate mechanical couplers 416, one or more pressing plates 418, and one or more receiving channels 420. In some embodiments, the substrate 412 may include and/or be formed of glass, silicon, and/or the like. As will be appreciated by those of ordinary skill in the art in view of this disclosure, the substrate 412 may include and/or be formed of other suitably, mechanically rigid materials.

As shown in FIGS. 4C and 4D, the FAU 410 and/or the substrate 412 may include fiber couplers 414 formed in a surface of the substrate 412, where the fiber couplers 414 extend substantially parallel to each other on the surface of the substrate 412, in some embodiments. For example, and as shown in FIGS. 4C and 4D, the fiber couplers 414 may extend from a first edge of the substrate 412 to a second edge of the substrate 412, opposite the first edge, across the surface of the substrate 412. The fiber couplers 414 may define a pattern corresponding to an arrangement of optical fibers with a predefined pitch between the grooves. Both the pattern and the pitch can vary in form or value.

As shown in FIGS. 4A-4E, the fiber couplers 414 may be configured to receive the optical fibers 402. In other words, the fiber couplers 414 may be configured such that the optical fibers 402 may be positioned in the fiber couplers 414. For example, each of the fiber couplers 414 may be configured to receive an optical fiber of the optical fibers 402. As will be appreciated by those of ordinary skill in the art in view of this disclosure, the FAU 410 may include one or more fiber couplers 414 that do not have an optical fiber positioned therein. As will also be appreciated by those of ordinary skill in the art in view of this disclosure, the FAU 410 may include fewer or more fiber couplers 414 than shown in FIGS. 4A-4E.

In some embodiments, the fiber couplers 414 may be uniformly spaced apart from each other along a width of the substrate 412, as shown in FIGS. 4A-4E. In this way, when the optical fibers 402 are positioned in the fiber couplers 414, the fiber couplers 414 may precisely align and/or arrange the optical fibers 402 into an array within the substrate 412 of the FAU 410.

In some embodiments, the fiber couplers 414 may be and/or include v-grooves, u-grooves, half-cylindrical grooves, and/or the like. Additionally, or alternatively, the fiber couplers 414 may be configured for receiving single mode optical fibers, multi-mode optical fibers, and/or the like. For example, the fiber couplers 414 may have maximum depths below the surface of the substrate 412 configured to position the respective optical fibers 402 such that respective cores of the respective optical fibers 402 are approximately 62.5 microns below the surface of the substrate 412.

As shown in FIGS. 4C and 4D, the FAU 410 and/or the substrate 412 may include substrate mechanical couplers 416 formed in a surface of the substrate 412, where the substrate mechanical couplers 416 extend substantially parallel to each other on the surface of the substrate 412, in some embodiments. For example, and as shown in FIGS. 4C and 4D, the substrate mechanical couplers 416 may extend from a first edge of the substrate 412 to a second edge of the substrate 412, opposite the first edge, across the surface of the substrate 412.

As shown in FIGS. 4A and 4B, the substrate mechanical couplers 416 may be configured to receive and/or mechanically couple with corresponding receptacle mechanical couplers 436 on the receptacle 430. In other words, the substrate mechanical couplers 416 may be configured such that the receptacle mechanical couplers 436 may be positioned in the substrate mechanical couplers 416. For example, each of the substrate mechanical couplers 416 may be configured to receive a corresponding receptacle mechanical coupler of the receptacle mechanical couplers 436. As will be appreciated by those of ordinary skill in the art in view of this disclosure, the FAU 410 may include one or more substrate mechanical couplers 416 that do not have a corresponding receptacle mechanical coupler. As will also be appreciated by those of ordinary skill in the art in view of this disclosure, the FAU 410 may include fewer or more substrate mechanical couplers 416 than shown in FIGS. 4A-4E.

In some embodiments, and as shown in FIGS. 4B, 4D, and 4E, the substrate mechanical couplers 416 and the fiber couplers 414 may have a same geometry in the surface of the substrate 412. Additionally, or alternatively, the substrate mechanical couplers 416 may be and/or include v-grooves, u-grooves, half-cylindrical grooves, and/or the like. In some embodiments, the substrate mechanical couplers 416 may be configured to be capable of receiving single mode optical fibers, multi-mode optical fibers, and/or the like. For example, the substrate mechanical couplers 416 may have maximum depths below the surface of the substrate 412 configured to position respective optical fibers, if placed in the substrate mechanical couplers 416, such that respective cores of the respective optical fibers are approximately 62.5 microns below the surface of the substrate 412. As another example, the substrate mechanical couplers 416 may have the same maximum depths as the maximum depths of the fiber couplers 414.

In some embodiments, the fiber couplers 414 and the substrate mechanical couplers 416 may be formed in the surface of the substrate 412 via a same process. For example, the fiber couplers 414 and the substrate mechanical couplers 416 may both be mechanically etched or engraved (e.g., using a dicing saw with a blade) in the surface of the substrate 412 (e.g., using the same equipment, technique, and/or the like). As another example, the fiber couplers 414 and the substrate mechanical couplers 416 may both be chemically etched (e.g., simultaneously) in the surface of the substrate 412 (e.g., using the same equipment, technique, and/or the like). By forming the fiber couplers 414 and the substrate mechanical couplers 416 in the surface of the substrate 412 via the same process, any inaccuracy in the depth of the fiber couplers 414 will also exist in the substrate mechanical couplers 416. Thus, depth-wise positional differences of optical fibers 402 in different FAUs due to inaccuracies in depths of fiber couplers 414 may be compensated for by the substrate mechanical couplers 416 when positioned in the receptacle 430, and the optical fibers 402 of the FAUs may be accurately aligned with optical elements of the receptacle 430 (e.g., a mirror 438, a microlens array 442, and/or the like as further described herein). Furthermore, because the substrate mechanical couplers 416 compensate for the depth-wise positional differences of optical fibers 402 in different FAUs, the receptacle 430 can be configured to detachably receive different FAUs, thereby achieving a detachable connector that precisely aligns optical fibers (e.g., to a tolerance of less than a micron).

As noted, the FAU 410 may include one or more pressing plates 418. In some embodiments, the pressing plate 418 may include and/or be formed of glass, silicon, and/or the like. As will be appreciated by those of ordinary skill in the art in view of this disclosure, the pressing plate 418 may include and/or be formed of other suitably, mechanically rigid materials.

As shown in FIGS. 4A-4E, the pressing plate 418 may be positioned on the fiber couplers 414 and the substrate 412. In some embodiments, adhesive may be applied to the fiber couplers 414 and/or the substrate 412, the optical fibers 402 may be positioned in the fiber couplers 414, and the pressing plate 418 may be used press the optical fibers 402 into the respective fiber couplers 414. In this way, the pressing plate 418 may assist with mechanically securing the optical fibers 402 in the fiber couplers 414 and precisely aligning the optical fibers 402 in an array within the substrate 412.

As will be appreciated by those of ordinary skill in the art in view of this disclosure, the FAU 410 may include one or more pressing plates 418 having different shapes as compared to that shown in FIGS. 4A-4E. As will also be appreciated by those of ordinary skill in the art in view of this disclosure, the FAU 410 may include fewer or more pressing plates 418 than shown in FIGS. 4A-4E.

As noted, the FAU 410 may include one or more receiving channels 420. In some embodiments, and as shown in FIGS. 4A and 4D, the receiving channels 420 may be formed in the substrate 412. For example, the receiving channels 420 may be notches, indentations, grooves, and/or the like formed in the substrate 412 providing a mechanical reference for the position of the FAU 410. Each of the receiving channels 420 may be configured to be engaged by a corresponding latching mechanism 440 on the receptacle 430. In this way, the receiving channels 420 and the latching mechanisms 440 may detachably secure the FAU 410 to the receptacle 430.

As will be appreciated by those of ordinary skill in the art in view of this disclosure, the FAU 410 may include one or more receiving channels 420 having different designs, configurations, shapes, features, and/or the like as compared to that shown in FIGS. 4A and 4D. As will also be appreciated by those of ordinary skill in the art in view of this disclosure, the FAU 410 may include fewer or more receiving channels 420 than shown in FIGS. 4A and 4D. Furthermore, the FAU 410 may also include one or more latching mechanisms (e.g., similar to the latching mechanisms 440) instead of or in addition to the receiving channels 420 configured to engage one or more receiving channels (e.g., similar to the receiving channels 420) of the receptacle 430.

As shown in FIGS. 4A and 4C, the receptacle 430 may be positioned on the optical device 450. In some embodiments, the receptacle 430 may be secured to the optical device 450 (e.g., using an adhesive). As shown in FIG. 4C, the receptacle 430 may be actively aligned before being secured to the optical device 450 such that an optical path 460 through the receptacle 430 is aligned with an optical window 452 of the optical device 450.

The receptacle 430 may include a receptacle body 432, one or more receptacle mechanical couplers 436, one or more optical elements, such as a mirror 438 (See FIGS. 4B and 4C), a microlens array 442 (See FIG. 4C), a prism (e.g., an optical folding prism), and/or the like, and one or more latching mechanisms 440. In some embodiments, and as shown in FIG. 4C, the receptacle body 432 may include a mechanical body 432a and an optical body 432b assembled together by an adhesive forming one body. Additionally, or alternatively, the receptacle body 432 may be monolithic. In some embodiments, the mirror 438 may be a folding mirror, a flat mirror, a curved mirror, and/or the like.

In some embodiments, the receptacle body 432, the mechanical body 432a, and/or the optical body 432b may include and/or be formed of glass, molded glass, silicon, plastic, polymer, and/or the like. As will be appreciated by those of ordinary skill in the art in view of this disclosure, the receptacle body 432, the mechanical body 432a, and/or the optical body 432b may include and/or be formed of other suitably, mechanically rigid materials.

As shown in FIGS. 4A and 4B, the receptacle 430 may include a pair of receptacle mechanical couplers 436, where each receptacle mechanical coupler is configured to mechanically couple with a corresponding substrate mechanical coupler of the substrate mechanical couplers 416. Furthermore, each receptacle mechanical coupler of the receptacle mechanical couplers 436 may be configured such that one or more optical elements (e.g., the mirror 438, the microlens array 442, and/or the like) optically couples the optical device 450 and the optical fibers, as shown in FIG. 4C.

In some embodiments, and as shown in FIGS. 4A and 4B, the receptacle mechanical couplers 436 may extend upward from a surface of the receptacle body 432. The receptacle mechanical couplers 436 may extend substantially parallel to each other on the surface of the receptacle body 432. For example, the receptacle mechanical couplers 436 may extend from a first edge of a surface of the mechanical body 432a to a second edge of the mechanical body 432a, opposite the first edge, across the surface of the mechanical body 432a.

As shown in FIGS. 4A and 4B, the receptacle mechanical couplers 436 may be configured to receive and/or mechanically couple with corresponding substrate mechanical couplers 416 on the FAU 410. In other words, the receptacle mechanical couplers 436 may be configured to be positioned in the substrate mechanical couplers 416. For example, each of the receptacle mechanical couplers 436 may be configured to be positioned in a corresponding substrate mechanical coupler of the substrate mechanical couplers 416. As will be appreciated by those of ordinary skill in the art in view of this disclosure, the receptacle 430 may include fewer or more receptacle mechanical couplers 436 than shown in FIGS. 4A and 4B.

In some embodiments, and as shown in FIGS. 4A and 4B, the receptacle mechanical couplers 436 may have a complementary geometry to a geometry of the substrate mechanical couplers 416. In other words, the geometry of the receptacle mechanical couplers 436 may pair with the geometry of the substrate mechanical couplers 416 such that the substrate mechanical couplers 416 may receive the receptacle mechanical couplers 436. Additionally, or alternatively, the receptacle mechanical couplers 436 have a complementary geometry to a geometry of the fiber couplers 414. In some embodiments, and as shown in FIGS. 4A and 4B, when the substrate 412 of the FAU 410 is positioned in/on the receptacle body 432 of the receptacle 430, the receptacle mechanical couplers 436 extend into the substrate mechanical couplers 416.

As noted, the receptacle 430 may include one or more optical elements, such as a mirror 438 (See FIGS. 4B and 4C), a microlens array 442 (See FIG. 4C), a prism, and/or the like. As shown in FIG. 4C, the optical elements may be formed in the optical body 432b. In some embodiments, the mirror 438 may include folding optics, such as a folding mirror, a curved mirror, and/or the like. Additionally, or alternatively, the one or more optical elements of the receptacle may be configured to optically couple the optical device 450, namely the optical window 452, and the optical fibers 402 positioned in the FAU 410.

As will be appreciated by those of ordinary skill in the art in view of this disclosure, the receptacle 430 may include fewer or more optical elements than shown in FIGS. 4B and 4C. As will also be appreciated by those of ordinary skill in the art in view of this disclosure, the receptacle 430 may include differently configured, arranged, and/or positioned optical elements than shown in FIGS. 4B and 4C. For example, the receptacle 430 may include optical elements configured to couple the optical fibers 402 into differently configured optical devices, such as edge-coupling devices, edge-emitting devices, electro-absorption modulated lasers (EMLs), edge SiPs (Systems in Package), and/or the like.

As noted, the receptacle 430 may include one or more latching mechanisms 440. In some embodiments, and as shown in FIG. 4A, the latching mechanisms 440 may be formed on the receptacle body 432. For example, the latching mechanisms 440 may be hooks, claws, latches, and/or the like extending from a surface of the receptacle body 432 that engages the FAU 410. Each of the latching mechanisms 440 may be configured to engage a corresponding receiving channel 420 on the FAU 410. In this way, the receiving channels 420 and the latching mechanisms 440 may detachably secure the FAU 410 to the receptacle 430.

As will be appreciated by those of ordinary skill in the art in view of this disclosure, the receptacle 430 may include one or more latching mechanisms 440 having different designs, configurations, shapes, features, and/or the like as compared to that shown in FIG. 4A. As will also be appreciated by those of ordinary skill in the art in view of this disclosure, the receptacle 430 may include fewer or more latching mechanisms 440 than shown in FIG. 4A. Furthermore, the receptacle 430 may also include one or more receiving channels (e.g., similar to the receiving channels 420) instead of or in addition to the latching mechanisms 440 configured to engage one or more latching mechanisms (e.g., similar to the latching mechanisms 440) of the FAU 410.

As will be appreciated by those of ordinary skill in the art in view of this disclosure, FIGS. 4A-4E depict a simplified and/or representative design for an optical connector, a fiber array unit, and a receptacle, in accordance with embodiments of the disclosure. For example, the optical connector 400 may include differently sized, shaped, and/or positioned fiber array units and/or receptacles. As another example, the receptacle 430 may include differently sized, shaped, positioned, and/or configured optical elements for coupling optical fibers of the FAU 410 with optical windows of other optical devices. As yet another example, the FAU 410 may include one or more optical elements configured for coupling optical fibers with optical windows of other optical devices (e.g., while the receptacle 430 does not include optical elements). As yet another example, both the receptacle 430 and the FAU 410 may both include one or more optical elements configured for coupling optical fibers with optical windows of other optical devices.

### Example Co-Packaged Networking Device

Co-packaging may refer to the close integration of different electrical and/or optoelectronic chips in the same package.

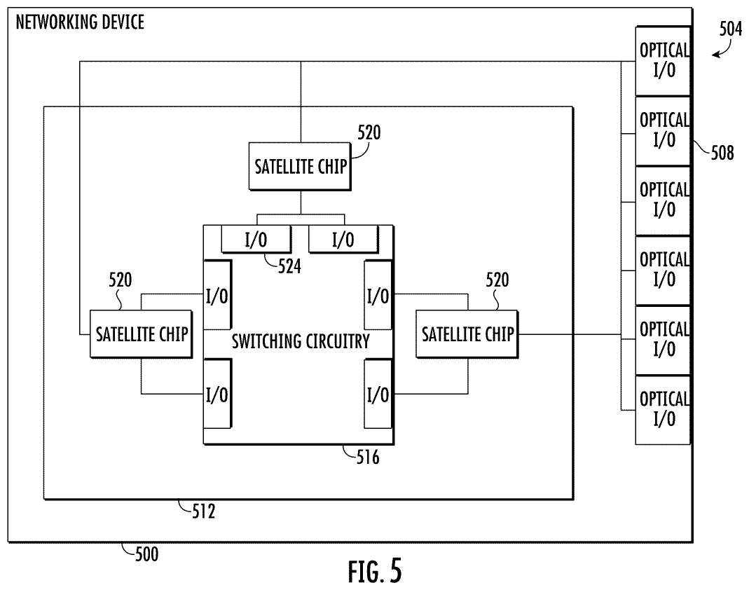

FIG. 5 is a block diagram that schematically illustrates a co-packaged Networking Device 500, in accordance with an embodiment that is disclosed herein. The different chips that constitute a co-packaged Networking Device are assembled on a single substrate in what is typically called the MCM assembly 512. The MCM assembly 512 can include a switching circuitry 516 surrounded by peripheral or satellite chips 520. In some embodiments, the switching circuitry 516 and surrounding satellite chips 520 are all mounted on a common substrate, although such a configuration is not required. The MCM assembly 512 may be provided in a larger housing of the networking device 500, positioned behind the front panel 504. The switching circuitry 516 may include one or more core digital Application Specific Integrated Circuits (ASICs), CPUs, GPUs, microprocessors, FPGAs, combinations thereof, and the like. The switching circuitry 516 may include a number of input ports and/or output ports 524. The Input/Output (I/O) ports 524 may include electrical ports and/or optical ports. Additionally, the switching circuitry 516 may include a combination of electrical blocks and optical blocks. The electrical blocks of the switching circuitry 516 may include a number of electrical switches that are configured to route signals in an electrical domain. The optical blocks of the switching circuitry 516 may include a number of optical components that are configured to generate, detect and route signals in an optical domain. The MCM assembly 512, in some embodiments, may concern or include multiple satellite chips 520 that are assembled on the same substrate as the switching circuitry 516. In some embodiments, a configuration of the optical block(s) and a configuration of the electrical block(s) depends (e.g., is based on) on the number of optical ports in the I/O ports 524.

As discussed above, optical I/Os 508, which may also be referred to as optical connectors, are placed at the front panel 504. As mentioned above, connectivity between the MCM assembly 512 and optical I/Os 508 may be transferred to the front panel 504 through optical fibers. This connection may be made directly with an optical I/O 524 of the switching circuitry 516 or may be made with one or more of the satellite chips 520. The connection is often made with one or more of the satellite chips 520 because the satellite chips 520 may include the electro-optic converters and, possibly, the SERDES to natively support the connection. The satellite chips 520 may include one or more of a DSP processor, driver, transimpedance amplifier, laser, modulator, photodiode, serializer-deserializer, and/or the like.

### Example System Circuitry

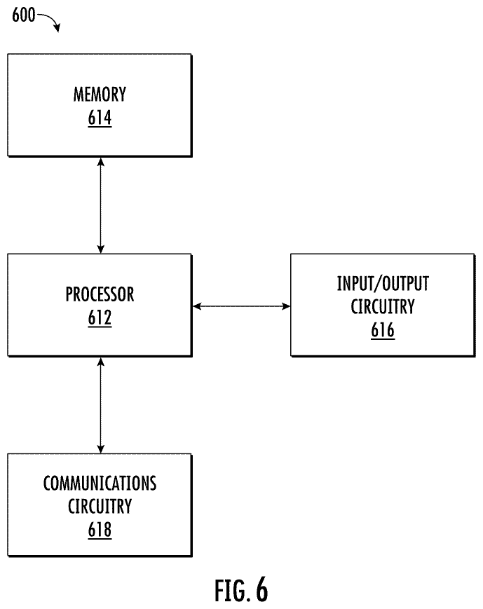

FIG. 6 illustrates a schematic block diagram of example circuitry 600, some or all of which may be included in an electronic module (e.g., the electronic module 300 shown and described herein with respect to FIG. 3), a photonic IC (e.g., the photonic IC 318 shown and described herein with respect to FIG. 3), an optical device (e.g., the optical device 450 shown and described herein with respect to FIGS. 4A-4C), a networking device (e.g., the networking device 500 shown and described herein with respect to FIG. 5), and/or the like. As shown in FIG. 6, the circuitry 600 may include a processor 612, a memory 614, input/output circuitry 616, and communications circuitry 618. It should be understood that FIG. 6 is merely an illustrative embodiment and the circuitry 600 may include more components, fewer components, or different components than those depicted. The arrangement of the components may also vary. Depending on specific implementation requirements, the circuitry 600 may incorporate additional components or omit certain components. Variations in the configuration and composition of the circuitry 600 are within the scope of the disclosure.

Although the term “circuitry” as used herein with respect to components 612-618 is described in some cases using functional language, it should be understood that the particular implementations necessarily include the use of particular hardware configured to perform the functions associated with the respective circuitry as described herein. It should also be understood that certain of these components 612-618 may include similar or common hardware. For example, two sets of circuitries may both leverage use of the same processor, network interface, storage medium, or the like to perform their associated functions, such that duplicate hardware is not required for each set of circuitries. It will be understood in this regard that some of the components described in connection with the circuitry 600 may be housed together, while other components are housed separately (e.g., a controller in communication with the circuitry 600). While the term “circuitry” should be understood broadly to include hardware, in some embodiments, the term “circuitry” may also include software for configuring the hardware. For example, in some embodiments, “circuitry” may include processing circuitry, storage media, network interfaces, input/output devices, and the like. In some embodiments, other elements of the circuitry 600 may provide or supplement the functionality of particular circuitry. For example, the processor 612 may provide processing functionality, the memory 614 may provide storage functionality, the communications circuitry 618 may provide network interface functionality, and/or the like.

In some embodiments, the processor 612 (and/or co-processor or any other processing circuitry assisting or otherwise associated with the processor) may be in communication with the memory 614 via a bus for passing information among components of, for example, the circuitry 600. The memory 614 may be non-transitory and may include, for example, one or more volatile and/or non-volatile memories, or some combination thereof. In other words, for example, the memory 614 may be an electronic storage device (e.g., a non-transitory computer readable storage medium). The memory 614 may be configured to store information, data, content, applications, instructions, or the like, for enabling an apparatus to carry out various functions in accordance with example embodiments of the present disclosure.

Although illustrated in FIG. 6 as a single memory, the memory 614 may include a plurality of memory components. The plurality of memory components may be embodied on a single computing device or distributed across a plurality of computing devices. In various embodiments, the memory 614 may include, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 614 may be configured to store information, data, applications, instructions, and/or the like for enabling the circuitry 600 to carry out various functions in accordance with example embodiments discussed herein. For example, in at least some embodiments, the memory 614 may be configured to buffer data for processing by the processor 612. Additionally, or alternatively, in at least some embodiments, the memory 614 may be configured to store program instructions for execution by the processor 612. The memory 614 may store information in the form of static and/or dynamic information. This stored information may be stored and/or used by the circuitry 600 during the course of performing its functionalities.

The processor 612 may be embodied in a number of different ways and may, for example, include one or more processing devices configured to perform independently. Additionally, or alternatively, the processor 612 may include one or more processors configured in tandem via a bus to enable independent execution of instructions, pipelining, and/or multithreading. The processor 612 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 6 as a single processor, in some embodiments, the processor 612 may include a plurality of processors. The plurality of processors may be embodied on a single computing device or may be distributed across a plurality of such devices collectively configured to function as the circuitry 600. The plurality of processors may be in operative communication with each other and may be collectively configured to perform one or more functionalities of the circuitry 600 as described herein.

In an example embodiment, the processor 612 may be configured to execute instructions stored in the memory 614 or otherwise accessible to the processor 612. Alternatively, or additionally, the processor 612 may be configured to execute hard-coded functionality. As such, whether configured by hardware or software methods, or by a combination thereof, the processor 612 may represent an entity (e.g., physically embodied in circuitry) capable of performing operations according to an embodiment of the present disclosure while configured accordingly. Alternatively, as another example, when the processor 612 is embodied as an executor of software instructions, the instructions may specifically configure the processor 612 to perform one or more algorithms and/or operations described herein when the instructions are executed. For example, these instructions, when executed by the processor 612, may cause the circuitry 600 to perform one or more of the functionalities thereof as described herein.

In some embodiments, the circuitry 600 further includes input/output circuitry 616 that may, in turn, be in communication with the processor 612 to provide an audible, visual, mechanical, or other output and/or, in some embodiments, to receive an indication of an input from a user or another source. In that sense, the input/output circuitry 616 may include means for performing analog-to-digital and/or digital-to-analog data conversions. The input/output circuitry 616 may include support, for example, for a display, touchscreen, keyboard, mouse, image capturing device (e.g., a camera), microphone, and/or other input/output mechanisms. The input/output circuitry 616 may include a user interface and may include a web user interface, a mobile application, a kiosk, or the like. The input/output circuitry 616 may interface with one or more units, devices, sensors, actuators, communication modules, storage devices, external processing units, peripheral devices, and/or the like. These outputs may then be transmitted to one or more destinations, such as display units, storage systems, control systems, processors (e.g., processor 612), network interfaces, peripheral devices, external systems, and/or the like, for further action.

The processor 612 and/or user interface circuitry including the processor 612 may be configured to control one or more functions of a display or one or more user interface elements through computer-program instructions (e.g., software and/or firmware) stored on a memory accessible to the processor 612 (e.g., the memory 614, and/or the like). In some embodiments, aspects of input/output circuitry 616 may be reduced as compared to embodiments where the circuitry 600 may be implemented as an end-user machine or other type of device designed for complex user interactions. In some embodiments (like other components discussed herein), the input/output circuitry 616 may be eliminated from the circuitry 600. The input/output circuitry 616 may be in communication with memory 614, communications circuitry 618, and/or any other component(s), such as via a bus. Although more than one input/output circuitry and/or other component can be included in the circuitry 600, only one is shown in FIG. 6 to avoid overcomplicating the disclosure (e.g., as with the other components discussed herein).

The communications circuitry 618, in some embodiments, includes any means, such as a device or circuitry embodied in either hardware, software, firmware or a combination of hardware, software, and/or firmware, that is configured to receive and/or transmit data from/to a network and/or any other device, or circuitry associated therewith. In this regard, the communications circuitry 618 may include, for example, a network interface for enabling communications with a wired or wireless communication network. For example, in some embodiments, communications circuitry 618 may be configured to receive and/or transmit any data that may be stored by the memory 614 using any protocol that may be used for communications between computing devices. For example, the communications circuitry 618 may include one or more network interface controllers, antennae, transmitters, receivers, buses, switches, routers, modems, and supporting hardware and/or software, and/or firmware/software, or any other device suitable for enabling communications via a network. Additionally, or alternatively, in some embodiments, the communications circuitry 618 may include circuitry for interacting with the antenna(s) to cause transmission of signals via the antenna(e) or to handle receipt of signals received via the antenna(e). These signals may be transmitted by the circuitry 600 using any of a number of wireless personal area network (PAN) technologies, such as Bluetooth® v1.0 through v5.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. The communications circuitry 618 may additionally or alternatively be in communication with the memory 614, the input/output circuitry 616, and/or any other component of the circuitry 600, such as via a bus.

In some embodiments, the circuitry 600 may include hardware, software, firmware, and/or a combination of such components, configured to support various aspects of the disclosure, as described herein. Additionally, or alternatively, in some implementations, the circuitry 600 may include hardware, software, firmware, and/or a combination thereof, that interacts with the memory 614 to send, retrieve, update, and/or store data.

Accordingly, non-transitory computer readable storage media, which may, for example, be the memory 614, can be configured to store firmware, one or more application programs, and/or other software, which include instructions and/or other computer-readable program code portions that can be executed to direct operation of the circuitry 600 to implement various operations, including the examples described herein. As such, a series of computer-readable program code portions may be embodied in one or more computer-program products and can be used, with a device, circuitry 600, database, and/or other programmable apparatus, to produce the machine-implemented processes discussed herein. It is also noted that all or some of the information discussed herein can be based on data that is received, generated and/or maintained by one or more components of the circuitry 600. In some embodiments, one or more external systems (such as a remote cloud computing and/or data storage system) may also be leveraged to provide at least some of the functionality discussed herein.

### Example Computer System

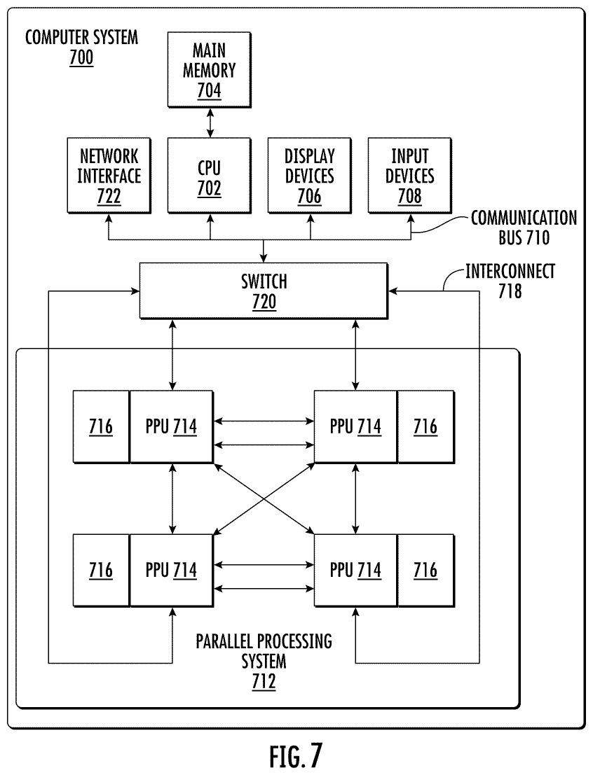

FIG. 7 illustrates a computer system 700, according to at least one embodiment. In at least one embodiment, computer system 700 is configured to implement various processes and methods described throughout this disclosure.

In at least one embodiment, computer system 700 comprises, without limitation, at least one central processing unit (“CPU”) 702 that is connected to a communication bus 710 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 700 includes, without limitation, a main memory 704 and control logic (e.g., implemented as hardware, software, or a combination thereof) and data are stored in main memory 704 which may take form of random access memory (“RAM”). In at least one embodiment, a network interface subsystem (“network interface”) 722 provides an interface to other computing devices and networks for receiving data from and transmitting data to other systems from computer system 700.

In at least one embodiment, computer system 700 includes, without limitation, input devices 708, parallel processing system 712, and display devices 706 which can be implemented using a conventional cathode ray tube (“CRT”), liquid crystal display (“LCD”), light emitting diode (“LED”), plasma display, or other suitable display technologies. In at least one embodiment, user input is received from input devices 708 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 704 and/or secondary storage. Computer programs, if executed by one or more processors, enable system 700 to perform various functions in accordance with at least one embodiment. memory 704, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 702; parallel processing system 712; an integrated circuit capable of at least a portion of capabilities of both CPU 702; parallel processing system 712; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 700 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 712 includes, without limitation, a plurality of parallel processing units (“PPUs”) 714 and associated memories 716. In at least one embodiment, PPUs 714 are connected to a host processor or other peripheral devices via an interconnect 718 and a switch 720 or multiplexer. In at least one embodiment, parallel processing system 712 distributes computational tasks across PPUs 714 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 714, although such shared memory may incur performance penalties relative to use of local memory and registers resident to a PPU 714. In at least one embodiment, operation of PPUs 714 is synchronized through use of a command such as _syncthreads( ), wherein all threads in a block (e.g., executed across multiple PPUs 714) to reach a certain point of execution of code before proceeding.

### Example System Use-case

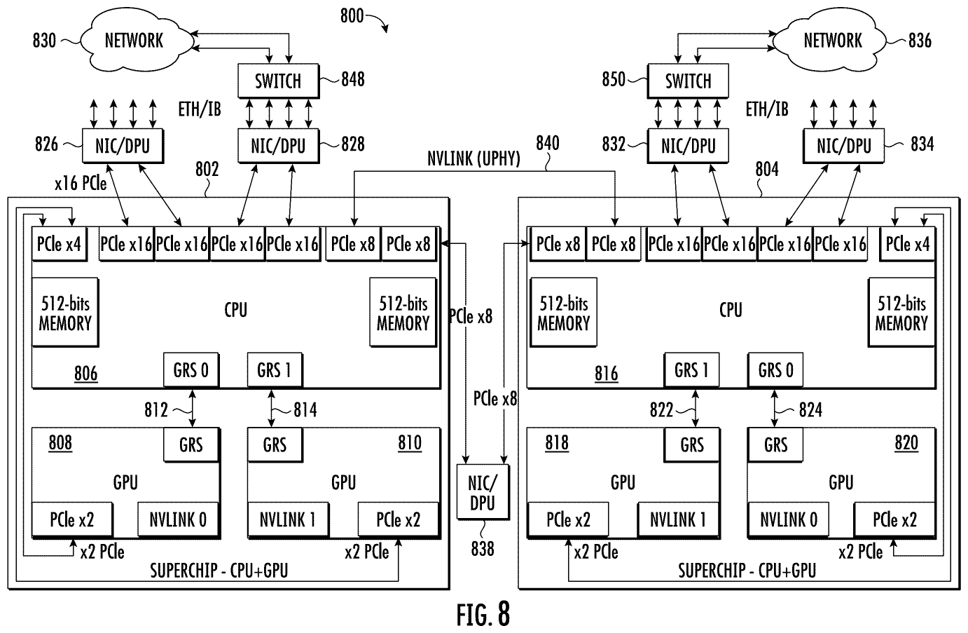

FIG. 8 is a block diagram that schematically illustrates a computing system 800, e.g., a data center or a High-Performance Computing (HPC) cluster, in accordance with an embodiment that is described herein. System 800 comprises a plurality of subsystems, e.g., multiple processing devices coupled to each other, multiple network devices, and multiple networks, according to at least one embodiment. Computing system 800 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 800 and to one or more external networks 830, 836. In the present example, computing system 800 comprises a packet switch 848 that connects NIC/DPU 828 to network 830, and a packet switch 850 that connects NIC/DPU 832 to network 836.

The coupling of processing devices through NVLink allows for seamless data exchange and parallel processing, enhancing overall computational performance. The processing devices are connected to multiple networks through one or more network interface controllers (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 800 can include one or more CPUs and one or more GPUs.

FIG. 8 also demonstrates an example architecture of a multi-GPU architecture. As illustrated in the figure, computing system 800 includes a processing device 802 with a multi-GPU architecture. In particular, processing device 802 may be a system-on-chip and includes multiple subsystems such as a CPU 806, a GPU 808, and a GPU 810. CPU 806 can be coupled to GPU 808 via a die-to-die (D2D) or chip-to-chip (C2C) interconnect 812, such as a Ground-Referenced Signaling interconnect (GRS interconnect). CPU 806 can be coupled to GPU 810 via a D2D or C2C interconnect 814. CPU 806 can also couple to GPU 808 and GPU 810 via PCIe interconnects.

CPU 806 can be coupled to one or more NICs or DPUs, which are coupled to one or more networks. For example, as illustrated in FIG. 8, CPU 806 is coupled to a first NIC/DPU 826, which is coupled to a network 830. CPU 806 is also coupled to a second NIC/DPU 828, which is coupled to network 830 via switch 848. NIC/DPU 826 and NIC/DPU 828 can be coupled to network 830 over Ethernet (ETH), NVLINK or InfiniBand (IB) connections, for example.

Computing system 800 also includes a processing device 804 with a multi-GPU architecture. In particular, processing device 804 includes multiple subsystems including a CPU 816, a GPU 818, and a GPU 820. CPU 816 can be coupled to GPU 818 via an D2D or C2C interconnect 822. CPU 816 can be coupled to GPU 820 via a D2D or C2C interconnect 824. CPU 816 can also couple to GPU 818 and GPU 820 via PCIe interconnects. CPU 816 can be coupled to one or more NICs or DPUs, which are coupled to one or more networks. For example, as illustrated in FIG. 8, CPU 816 is coupled to a first NIC/DPU 832, which is coupled to a network 836. CPU 816 is also coupled to a second NIC/DPU 834, which is coupled to network 836 via switch 850. NIC/DPU 832 and NIC/DPU 834 can be coupled to network 836 over Ethernet (ETH), NVLINK or InfiniBand (IB) connections.

In at least one embodiment, processing device 802 and processing device 804 can be in communication with each other via a NIC/DPU 838, such as over PCIe interconnects. Processing device 802 and processing device 804 can also communicate with each other over a high-bandwidth communication interconnect 840, such as an NVLink interconnect or other high-speed interconnects. The packet switches in FIG. 8 may include, for example, Nvidia Quantum-2 switches. The NICs/DPUs in the figure may include, for example, Nvidia Bluefield DPUs.

### Example Method of Manufacturing an Optical Connector

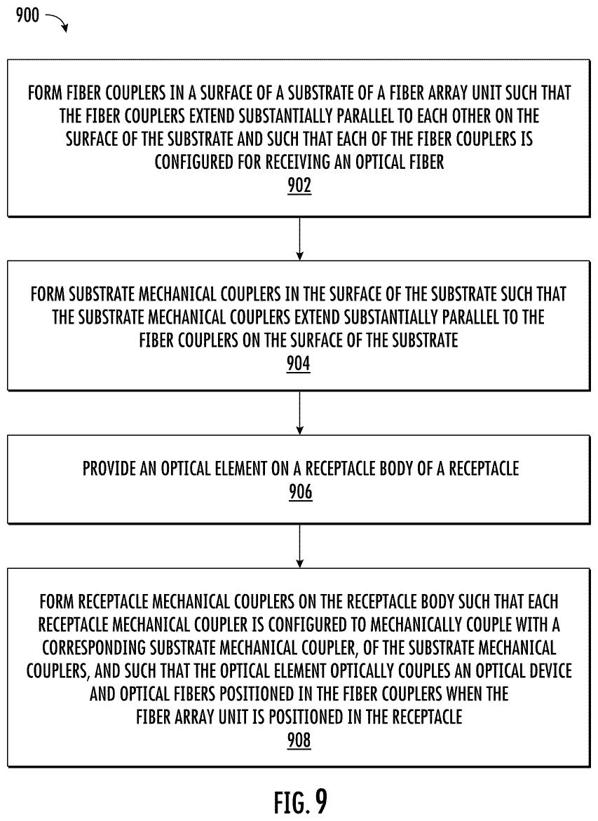

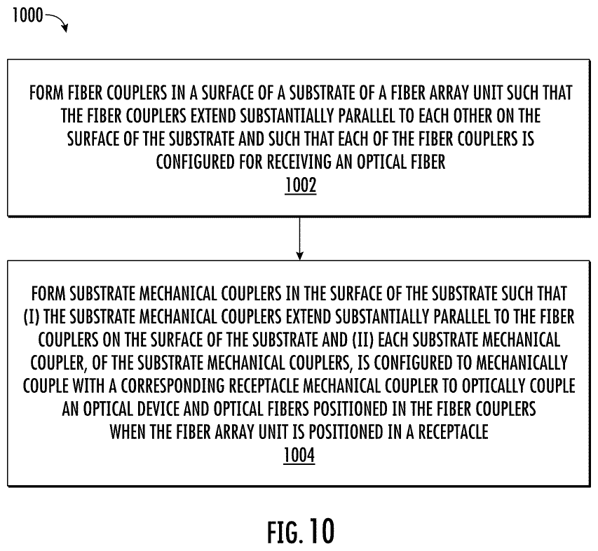

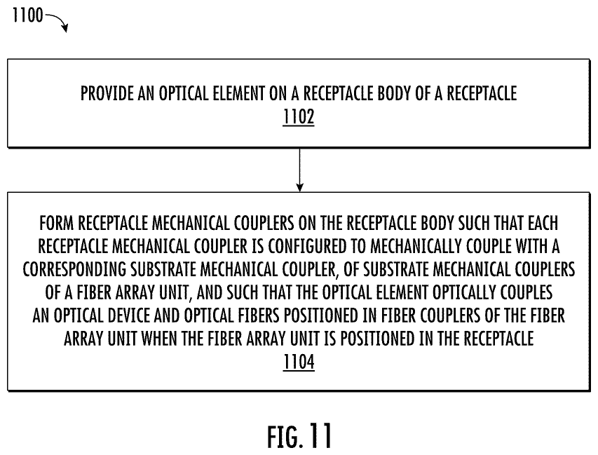

FIG. 9 is a flowchart illustrating a method 900 of manufacturing an optical connector, in accordance with an embodiment of the present disclosure. In some embodiments, the method 900 and/or steps described herein with respect to the method 900 may be performed in conjunction with and/or as one or more steps of the method 1000 described herein with respect to FIG. 10. Additionally, or alternatively, the method 900 and/or steps described herein with respect to the method 900 may be performed in conjunction with and/or as one or more steps of the method 1100 described herein with respect to FIG. 11. In some embodiments, the optical connector manufactured by the method 900 may be similar to the optical connector 400 shown and described herein with respect to FIGS. 4A-4C.

As shown in block 902, the method 900 may include forming fiber couplers in a surface of a substrate of a fiber array unit such that the fiber couplers extend substantially parallel to each other on the surface of the substrate and such that each of the fiber couplers is configured for receiving an optical fiber. For example, the method 900 may include forming fiber couplers similar to the fiber couplers 414 shown and described herein with respect to FIGS. 4A-4E. As another example, the method 900 may include forming fiber couplers in a surface of a substrate similar to the substrate 412 shown and described herein with respect to FIGS. 4A-4E. As yet another example, the method 900 may include forming fiber couplers in a surface of a substrate of a fiber array unit similar to the FAU 410 shown and described herein with respect to FIGS. 4A-4E. In some embodiments, the method 900 may include, when forming the fiber couplers in the surface of the substrate and when forming the substrate mechanical couplers in the surface of the substrate, forming the fiber couplers and forming the substrate mechanical couplers to have a same depth below the surface of the substrate.

Additionally, or alternatively, the method 900 may include forming the fiber couplers in the surface of the substrate comprises using a process to form the fiber couplers in the surface of the substrate and forming the substrate mechanical couplers in the surface of the substrate comprises using the same process to form the substrate mechanical couplers in the surface of the substrate. For example, the process may include mechanically etching the substrate (e.g., using a dicing saw with a blade) to form the fiber couplers and the substrate mechanical couplers. As another example, the process may include chemically etching the substrate to form the fiber couplers and the substrate mechanical couplers (e.g., simultaneously).

As shown in block 904, the method 900 may include forming substrate mechanical couplers in the surface of the substrate such that the substrate mechanical couplers extend substantially parallel to the fiber couplers on the surface of the substrate. For example, the method 900 may include forming substrate mechanical couplers similar to the substrate mechanical couplers 416 shown and described herein with respect to FIGS. 4A-4E.

In some embodiments, the method 900 may include positioning one or more optical-fiber ends of one or more optical fibers (e.g., similar to the optical fibers 402 shown and described herein with respect to FIGS. 4A-4E) in one or more fiber couplers of the fiber couplers. Additionally, or alternatively, the method 900 may include applying adhesive to a portion of the substrate, the one or more optical-fiber ends, and the one or more fiber couplers. In some embodiments, the method 900 may include positioning a pressing plate (e.g., similar to the pressing plate 418 shown and described herein with respect to FIGS. 4A-4E) of the fiber array unit on the adhesive, the portion of the substrate, and the one or more optical-fiber ends. Additionally, or alternatively, the method 900 may include applying pressure to the pressing plate to position the one or more optical-fiber ends in the one or more fiber couplers of the portion of the substrate.

As shown in block 906, the method 900 may include providing an optical element on a receptacle body of a receptacle. For example, the method 900 may include providing an optical element similar to one or more of the optical elements (e.g., the mirror 438, the microlens array 424, and/or the like) shown and described herein with respect to FIGS. 4A-4E. As another example, the method 900 may include providing an optical element on a receptacle body similar to the receptacle body 432 shown and described herein with respect to FIGS. 4A-4E. As yet another example, the method 900 may include providing an optical element on a receptacle body of a receptacle similar to the receptacle 430 shown and described herein with respect to FIGS. 4A-4E. In some embodiments, the optical element may be a first optical element (e.g., similar to the mirror 438 shown and described herein with respect to FIGS. 4A-4E), and the method 900 may include forming a second optical element (e.g., similar to the microlens array 424 shown and described herein with respect to FIGS. 4A-4E) such that (i) the first optical element optically couples the second optical element and the optical fibers positioned in the fiber couplers and (ii) the second optical element optically couples the optical device and the first optical element.

As shown in block 908, the method 900 may include forming receptacle mechanical couplers on the receptacle body such that each receptacle mechanical coupler is configured to mechanically couple with a corresponding substrate mechanical coupler, of the substrate mechanical couplers, and such that the optical element optically couples an optical device and optical fibers positioned in the fiber couplers when the fiber array unit is positioned in the receptacle. For example, the method 900 may include forming receptacle mechanical couplers similar to the receptacle mechanical couplers 436 shown and described herein with respect to FIGS. 4A-4E. In some embodiments, the method 900 may include securing the receptacle to an optical device (e.g., using an adhesive) and positioning the fiber array unit in the receptacle.

Additionally, or alternatively, the method 900 may include forming a receiving channel on the fiber array unit and forming a latching mechanism on the receptacle such that, when the fiber array unit is positioned on the receptacle, the latching mechanism engages the receiving channel to detachably secure the fiber array unit to the receptacle. For example, the receiving channel may be similar to the receiving channels 420 shown and described herein with respect to FIGS. 4A-4E. As another example, the latching mechanism may be similar to the latching mechanisms 440 shown and described herein with respect to FIGS. 4A-4E.

Method 900 may include additional embodiments, such as any single embodiment or any combination of embodiments described herein. Although FIG. 9 shows example blocks of method 900, in some embodiments, method 900 may include additional blocks, fewer blocks, different blocks, or differently arranged blocks than those depicted in FIG. 9. Additionally, or alternatively, two or more of the blocks of method 900 may be performed in parallel.

### Example Method of Manufacturing an FAU

FIG. 10 is a flowchart illustrating a method 1000 of manufacturing an FAU, in accordance with an embodiment of the present disclosure. In some embodiments, the method 1000 and/or steps described herein with respect to the method 1000 may be performed in conjunction with and/or as one or more steps of the method 900 described herein with respect to FIG. 9. Additionally, or alternatively, the method 1000 and/or steps described herein with respect to the method 1000 may be performed in conjunction with and/or as one or more steps of the method 1100 described herein with respect to FIG. 11. In some embodiments, the FAU manufactured by the method 1000 may be similar to the FAU 410 shown and described herein with respect to FIGS. 4A-4C.

As shown in block 1002, the method 1000 may include forming fiber couplers in a surface of a substrate of a fiber array unit such that the fiber couplers extend substantially parallel to each other on the surface of the substrate and such that each of the fiber couplers is configured for receiving an optical fiber. For example, the method 1000 may include forming fiber couplers similar to the fiber couplers 414 shown and described herein with respect to FIGS. 4A-4E. As another example, the method 1000 may include forming fiber couplers in a surface of a substrate similar to the substrate 412 shown and described herein with respect to FIGS. 4A-4E. As yet another example, the method 1000 may include forming fiber couplers in a surface of a substrate of a fiber array unit similar to the FAU 410 shown and described herein with respect to FIGS. 4A-4E. In some embodiments, the method 1000 may include, when forming the fiber couplers in the surface of the substrate and when forming the substrate mechanical couplers in the surface of the substrate, forming the fiber couplers and forming the substrate mechanical couplers to have a same depth below the surface of the substrate.

Additionally, or alternatively, the method 1000 may include forming the fiber couplers in the surface of the substrate comprises using a process to form the fiber couplers in the surface of the substrate and forming the substrate mechanical couplers in the surface of the substrate comprises using the same process to form the substrate mechanical couplers in the surface of the substrate. For example, the process may include mechanically etching the substrate (e.g., using a dicing saw with a blade) to form the fiber couplers and the substrate mechanical couplers. As another example, the process may include chemically etching the substrate to form the fiber couplers and the substrate mechanical couplers (e.g., simultaneously).

As shown in block 1004, the method 1000 may include forming substrate mechanical couplers in the surface of the substrate such that (i) the substrate mechanical couplers extend substantially parallel to the fiber couplers on the surface of the substrate and (ii) each substrate mechanical coupler, of the substrate mechanical couplers, is configured to mechanically couple with a corresponding receptacle mechanical coupler to optically couple an optical device and optical fibers positioned in the fiber couplers when the fiber array unit is positioned in a receptacle. For example, the method 1000 may include forming substrate mechanical couplers similar to the substrate mechanical couplers 416 shown and described herein with respect to FIGS. 4A-4E.

In some embodiments, the method 1000 may include positioning one or more optical-fiber ends of one or more optical fibers (e.g., similar to the optical fibers 402 shown and described herein with respect to FIGS. 4A-4E) in one or more fiber couplers of the fiber couplers. Additionally, or alternatively, the method 1000 may include applying adhesive to a portion of the substrate, the one or more optical-fiber ends, and the one or more fiber couplers. In some embodiments, the method 1000 may include positioning a pressing plate (e.g., similar to the pressing plate 418 shown and described herein with respect to FIGS. 4A-4E) of the fiber array unit on the adhesive, the portion of the substrate, and the one or more optical-fiber ends. Additionally, or alternatively, the method 1000 may include applying pressure to the pressing plate to position the one or more optical-fiber ends in the one or more fiber couplers of the portion of the substrate.

In some embodiments, the method 1000 may include forming a receiving channel on the fiber array unit such that, when the fiber array unit is positioned on the receptacle, the receiving channel is configured to be engaged by a latching mechanism on the receptacle to detachably secure the fiber array unit to the receptacle. For example, the receiving channel may be similar to the receiving channels 420 shown and described herein with respect to FIGS. 4A-4E. Additionally, or alternatively, the method 1000 may include positioning the fiber array unit in the receptacle while the receptacle is secured to the optical device.

Method 1000 may include additional embodiments, such as any single embodiment or any combination of embodiments described herein. Although FIG. 10 shows example blocks of method 1000, in some embodiments, method 1000 may include additional blocks, fewer blocks, different blocks, or differently arranged blocks than those depicted in FIG. 10. Additionally, or alternatively, two or more of the blocks of method 1000 may be performed in parallel.

### Example Method of Manufacturing a Receptacle

FIG. 11 is a flowchart illustrating a method 1100 of manufacturing a receptacle, in accordance with an embodiment of the present disclosure. In some embodiments, the method 1100 and/or steps described herein with respect to the method 1100 may be performed in conjunction with and/or as one or more steps of the method 900 described herein with respect to FIG. 9. Additionally, or alternatively, the method 1100 and/or steps described herein with respect to the method 1100 may be performed in conjunction with and/or as one or more steps of the method 1000 described herein with respect to FIG. 10. In some embodiments, the receptacle manufactured by the method 1100 may be similar to the receptacle 430 shown and described herein with respect to FIGS. 4A-4C.

As shown in block 1102, the method 1100 may include providing an optical element on a receptacle body of a receptacle. For example, the method 1100 may include providing an optical element similar to one or more of the optical elements (e.g., the mirror 438, the microlens array 424, and/or the like) shown and described herein with respect to FIGS. 4A-4E. As another example, the method 1100 may include providing an optical element on a receptacle body similar to the receptacle body 432 shown and described herein with respect to FIGS. 4A-4E. As yet another example, the method 1100 may include providing an optical element on a receptacle body of a receptacle similar to the receptacle 430 shown and described herein with respect to FIGS. 4A-4E. In some embodiments, the optical element may be a first optical element (e.g., similar to the mirror 438 shown and described herein with respect to FIGS. 4A-4E), and the method 1100 may include forming a second optical element (e.g., similar to the microlens array 424 shown and described herein with respect to FIGS. 4A-4E) such that (i) the first optical element optically couples the second optical element and the optical fibers positioned in the fiber couplers and (ii) the second optical element optically couples the optical device and the first optical element.

As shown in block 1104, the method 1100 may include forming receptacle mechanical couplers on the receptacle body such that each receptacle mechanical coupler is configured to mechanically couple with a corresponding substrate mechanical coupler, of substrate mechanical couplers of a fiber array unit, and such that the optical element optically couples an optical device and optical fibers positioned in fiber couplers of the fiber array unit when the fiber array unit is positioned in the receptacle. For example, the method 1100 may include forming receptacle mechanical couplers similar to the receptacle mechanical couplers 436 shown and described herein with respect to FIGS. 4A-4E.

In some embodiments, the method 1100 may include forming a latching mechanism on the receptacle such that, when the fiber array unit is positioned on the receptacle, the latching mechanism engages a receiving channel of the fiber array unit to detachably secure the fiber array unit to the receptacle. For example, the latching mechanism may be similar to the latching mechanisms 440 shown and described herein with respect to FIGS. 4A-4E. In some embodiments, the method 1100 may include securing the receptacle to an optical device (e.g., using an adhesive) and positioning the fiber array unit in the receptacle.

Method 1100 may include additional embodiments, such as any single embodiment or any combination of embodiments described herein. Although FIG. 11 shows example blocks of method 1100, in some embodiments, method 1100 may include additional blocks, fewer blocks, different blocks, or differently arranged blocks than those depicted in FIG. 11. Additionally, or alternatively, two or more of the blocks of method 1100 may be performed in parallel.

Although many embodiments of the present disclosure have just been described above, the present disclosure may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present disclosure described and/or contemplated herein may be included in any of the other embodiments of the present disclosure described and/or contemplated herein, and/or vice versa.

While certain exemplary embodiments have been described and shown in the accompanying drawings, it is to be understood that such embodiments are merely illustrative of and not restrictive on the broad disclosure, and that this disclosure is not limited to the specific constructions and arrangements shown and described, since various other changes, combinations, omissions, modifications, and substitutions, in addition to those set forth in the above paragraphs, are possible. Those skilled in the art will appreciate that various adaptations, modifications, and combinations of the just described embodiments may be configured without departing from the scope and spirit of the disclosure. For example, devices, modules, components, and/or elements shown in the figures are not necessarily drawn to scale and may vary from that shown without departing from the scope and spirit of the disclosure. Therefore, it is to be understood that the disclosure may be practiced other than as specifically described herein.

What is claimed is:

1. An optical connector, comprising:
a substrate comprising:
fiber couplers formed in a surface of the substrate, wherein the fiber couplers extend substantially parallel to each other on the surface of the substrate, and wherein each of the fiber couplers is configured for receiving an optical fiber; and
substrate mechanical couplers formed in the surface of the substrate, wherein the substrate mechanical couplers extend substantially parallel to the fiber couplers on the surface of the substrate; and
a receptacle comprising:
an optical element; and
receptacle mechanical couplers, wherein each receptacle mechanical coupler is configured to mechanically couple with a corresponding substrate mechanical coupler, of the substrate mechanical couplers, such that the optical element optically couples an optical device and optical fibers positioned in the fiber couplers; and
wherein the receptacle is configured to detachably receive the substrate.

2. The optical connector of claim 1, wherein the receptacle mechanical couplers have a complementary geometry to a geometry of the fiber couplers.

3. The optical connector of claim 1, wherein each substrate mechanical coupler is configured to receive a corresponding receptacle mechanical coupler, of the receptacle mechanical couplers.

4. The optical connector of claim 1, wherein, when the substrate is positioned in the receptacle, the receptacle mechanical couplers extend into the substrate mechanical couplers.

5. The optical connector of claim 1, wherein the optical element is a first optical element, wherein the receptacle comprises a second optical element.

6. The optical connector of claim 5, wherein the first optical element is configured to optically couple the second optical element and the optical fibers positioned in the fiber couplers, and wherein the second optical element is configured to optically couple the optical device and the first optical element.

7. The optical connector of claim 6, wherein the first optical element comprises a mirror, and wherein the second optical element comprises a microlens array.

8. The optical connector of claim 1, wherein the receptacle is configured to detachably receive different fiber array units.

9. A fiber array unit, comprising:
a substrate comprising:
fiber couplers formed in a surface of the substrate, wherein the fiber couplers extend substantially parallel to each other on the surface of the substrate, and wherein each of the fiber couplers is configured for receiving an optical fiber; and
substrate mechanical couplers formed in the surface of the substrate, wherein the substrate mechanical couplers extend substantially parallel to the fiber couplers on the surface of the substrate, and wherein each substrate mechanical coupler is configured to receive and mechanically couple with a corresponding receptacle mechanical coupler of a receptacle such that an optical element of the receptacle optically couples an optical device and optical fibers positioned in the fiber couplers; and
wherein the fiber array unit is configured to detachably connect to the receptacle.

10. The fiber array unit of claim 9, wherein the fiber couplers and the substrate mechanical couplers are formed in the surface of the substrate via a same process.

11. The fiber array unit of claim 9, wherein the fiber couplers and the substrate mechanical couplers have a same geometry in the surface of the substrate.

12. The fiber array unit of claim 9, wherein the fiber couplers and the substrate mechanical couplers extend from a first edge of the substrate to a second edge of the substrate, opposite the first edge, across the surface of the substrate.

13. The fiber array unit of claim 9, wherein the fiber couplers have a complementary geometry to a geometry of receptacle mechanical couplers of the receptacle.

14. A method of manufacturing an optical connector, the method comprising:
forming fiber couplers in a surface of a substrate of a fiber array unit such that the fiber couplers extend substantially parallel to each other on the surface of the substrate and such that each of the fiber couplers is configured for receiving an optical fiber;
forming substrate mechanical couplers in the surface of the substrate such that the substrate mechanical couplers extend substantially parallel to the fiber couplers on the surface of the substrate;
providing an optical element on a receptacle body of a receptacle; and
forming receptacle mechanical couplers on the receptacle body such that each receptacle mechanical coupler is configured to mechanically couple with a corresponding substrate mechanical coupler, of the substrate mechanical couplers, and such that the optical element optically couples an optical device and optical fibers positioned in the fiber couplers when the fiber array unit is positioned in the receptacle.

15. The method of claim 14, comprising, when forming the fiber couplers in the surface of the substrate and when forming the substrate mechanical couplers in the surface of the substrate, forming the fiber couplers and forming the substrate mechanical couplers to have a same depth below the surface of the substrate.

16. The method of claim 14, wherein:
forming the fiber couplers in the surface of the substrate comprises using a process to form the fiber couplers in the surface of the substrate; and
forming the substrate mechanical couplers in the surface of the substrate comprises using the same process to form the substrate mechanical couplers in the surface of the substrate.

17. The method of claim 16, wherein the process comprises mechanically etching the substrate to form the fiber couplers and the substrate mechanical couplers.

18. The method of claim 16, wherein the process comprises chemically etching the substrate to form the fiber couplers and the substrate mechanical couplers.

19. The method of claim 18, wherein forming the fiber couplers in the surface of the substrate and forming the substrate mechanical couplers in the surface of the substrate is performed simultaneously.

20. The method of claim 14, wherein the optical element is a first optical element, and wherein the method comprises forming a second optical element such that (i) the first optical element optically couples the second optical element and the optical fibers positioned in the fiber couplers and (ii) the second optical element optically couples the optical device and the first optical element.
